(19) United States
(12) Patent Application Publication
(10) Pub. No.: US 2011/0174124 A1
(43) Pub. Date: Jul. 21, 2011

(54) BAGEL CHIP SLICER

(75) Inventors: John Kortman, Grandville, MI (US); Scott Teliczan, Ada, MI (US)

(73) Assignee: Oliver Packaging and Equipment Company, Grand Rapids, MI (US)

(21) Appl. No.: 13/010,449

(22) Filed: Jan. 20, 2011

Related U.S. Application Data
(60) Provisional application No. 61/349,050, filed on May 27, 2010.
(60) Provisional application No. 61/296,959, filed on Jan. 21, 2010.

(51) Int. Cl. B26D 1/11; B26D 3/00

(52) U.S. Cl. 83/13; 83/697; 83/613

(57) ABSTRACT

A bagel slicing apparatus comprising providing a housing having a plurality of cutting blades, with the cutting blades moving linearly and reciprocally to slice a bagel into a plurality of bagel chips.

### FIELD OF THE INVENTION

The present invention generally relates to slicers, and more specifically relates to a slicer for slicing bagels into bagel chips.

### SUMMARY OF THE PRESENT INVENTION

An aspect of the present invention is to provide a method of slicing a bagel comprising providing a housing having a plurality of cutting blades, moving the bagel past the cutting blades to slice the bagel into a plurality of bagel chips, and moving the cutting blades linearly and reciprocally to slice the bagel.

Another aspect of the present invention is to provide a method of slicing a bagel comprising providing a housing having a plurality of cutting blades, moving the bagel past the cutting blades to slice the bagel into a plurality of bagel chips, and wherein a distance between adjacent cutting blades is equal to or less than 0.5 inches.

Yet another aspect of the present invention is to provide a method of slicing a bagel comprising, providing a housing having a plurality of cutting blades, and moving the bagel past the cutting blades to slice the bagel into a plurality of bagel chips, with the bagel chips having a thickness equal to or less than 0.5 inches.

A further aspect of the present invention is to provide a method of slicing a whole bagel comprising providing a housing having a plurality of cutting blades and moving the whole bagel past the cutting blades to slice the bagel into a plurality of bagel chips. Only one whole bagel is sliced during moving. Multiple bagel chips are simultaneously formed during moving the whole bagel past the cutting blades.

Another aspect of the present invention is to provide a bagel slicing apparatus comprising a housing having a plurality of cutting blades comprising a first set of cutting blades and a second set of cutting blades. The first set of cutting blades move as a first unit. The second set of cutting blades move as a second unit. The first set of cutting blades moves out of phase to the second set of cutting blades. A distance between adjacent cutting blades is equal to or less than 0.5 inches.

Yet another aspect of the present invention is to provide a bagel slicing apparatus comprising a housing having a plurality of cutting blades comprising a first set of cutting blades and a second set of cutting blades. The first set of cutting blades move as a first unitary unit. The second set of cutting blades move as a second unitary unit. The first set of cutting blades moves out of phase to the second set of cutting blades. The cutting blades move linearly and reciprocally to slice the bagel.

These and other aspects, objects, and features of the present invention will be understood and appreciated by those skilled in the art upon studying the following specification, claims, and appended drawings.

### BRIEF DESCRIPTION OF DRAWINGS

FIG. 1 is a front perspective view of a slicer of the present invention.

FIG. 2 is a front exploded perspective view of the slicer of the present invention.

FIG. 3 is a side view of the slicer of the present invention without a motor cover.

FIG. 4 is a rear view of the slicer of the present invention without the motor cover.

FIG. 5 is a top view of the slicer of the present invention without a cover and without a pusher handle.

FIG. 6 is a rear perspective view of the slicer of the present invention without the motor cover, the cover and the pusher handle.

FIG. 7 is a perspective view of a track of the present invention.

FIG. 8 is a top view of a cutting blade assembly of the present invention.

FIG. 9 is a cross section view of the cutting blade assembly of the present invention taken along the line IX-IX of FIG. 8.

FIG. 10 is a cross section view of the cutting blade assembly of the present invention taken along the line X-X of FIG. 9.

FIG. 11 is a side view of a cutting blade of the present invention.

FIGS. 12A-12C illustrates movement of the cutting blade assembly of the present invention.

FIG. 13 is a top view of the cover of the present invention.

FIG. 14 is a side view of the cover of the present invention.

FIG. 15 is a bottom view of the cover of the present invention.

FIG. 16 is a top view of the pusher handle of the present invention.

FIG. 17 is a front view of the pusher handle of the present invention.

FIG. 18 is a bottom view of the pusher handle of the present invention.

FIG. 19 is a side view of the slicer of the present invention with the pusher handle in a load position.

FIG. 20 is a top view of the slicer of the present invention with the pusher handle in the load position.

FIG. 21 is a cross section view of the slicer of the present invention taken along the line XXI-XXI of FIG. 20.

FIG. 21A is an enlarged view of section XXIA of FIG. 21.

FIG. 22 is a top view of the slicer of the present invention with the pusher handle in a cutting position.

FIG. 23 is a cross section view of the slicer of the present invention taken along the line XXIII-XXIII of FIG. 22.

FIG. 24 is a side view of the slicer of the present invention without a motor cover showing an alternative of the cover to the base.

FIG. 25 is a partial perspective view of the cover and the base illustrating a stay member for maintaining the cover of FIG. 24 in an open position.

FIG. 26 is a cross section view of the slicer of the present invention illustrating a connection between the cutting blade assembly and the output assembly.

FIG. 27 is a side view of a cam of the slicer of the present invention.

FIG. 28 is a front view of the slicer of the present invention.

FIG. 29 is a top view of a modified pusher handle of the present invention.

FIG. 30 is a top view of a modified cutting blade assembly of the present invention.

FIG. 31 is a cross section view of the cutting blade assembly of the present invention taken along the line XXXI-XXXI of FIG. 30.

FIG. 32 is a side view of a modified cutting blade of the present invention.

FIG. 33 is a side view of a second embodiment of an output assembly.

FIG. 34 is a front perspective view of a third embodiment of the slicer of the present invention.

FIG. 35 is an exploded front perspective view of the third embodiment of the slicer of the present invention.

FIG. 36 is a side view of the third embodiment of the slicer of the present invention with the pusher handle in a cutting position.

FIG. 37 is a side view of the third embodiment of the slicer of the present invention with the pusher handle in a load position.

FIG. 38 is a front view of the third embodiment of the slicer of the present invention.

FIG. 39 is a rear view of the third embodiment of the slicer of the present invention.

FIG. 40 is a top view of the third embodiment of the slicer of the present invention.

FIG. 41 is a front perspective view of the third embodiment of the slicer of the present invention with the cover in an open position.

### DETAILED DESCRIPTION OF PREFERRED EMBODIMENTS

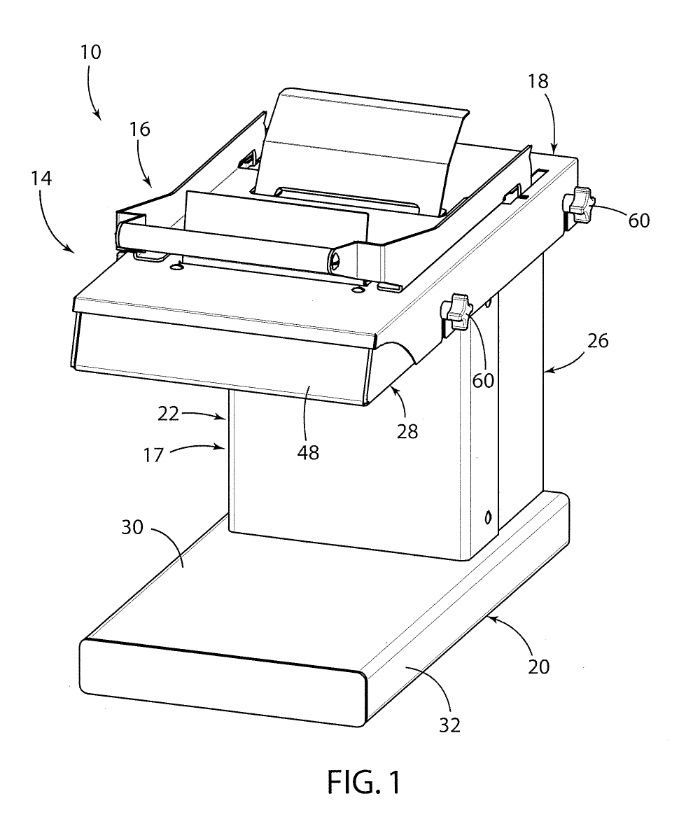

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The reference number 10 (FIG. 1) generally designates a slicer embodying the present invention. In the illustrated example, the slicer 10 is used to slice bagels or other bread items into chips. As used herein, a bagel is a bread product having a generally ring (with a center hole) or horn (without a center hole) toroid. The slicer 10 is able to slice the bagel or other bread product into bagel chips. As used herein, a bagel chip is a bread product in the shape of a chip. As discussed in more detail below, the slicer 10 of the present invention can slice a bagel into chips having a width less than ⅛ of an inch (0.125 inches). The slicer 10 includes a cutting blade assembly 12 configured to slice the bagels, a housing 14 for the cutting blade assembly 12 and a pusher handle 16 for pushing the bagels through the cutting blade assembly 12.

In the illustrated example, the housing 14 retains the cutting blade assembly 12 and allows the cutting blade assembly 12 to slice the bread product into a chip. The illustrated housing 14 includes a base 17 and a cover 18. The cover 18 covers the base 17 to retain the cutting blade assembly 12 within the housing 14. The base 17 comprises a pedestal 20, a column 22, a motor assembly 24, a motor cover 26 and a platform 28. The platform 28 is configured to receive the cutting blade assembly 12 and the cover 18 and the motor assembly 24 moves the cutting blade assembly 12 to slice the bread product.

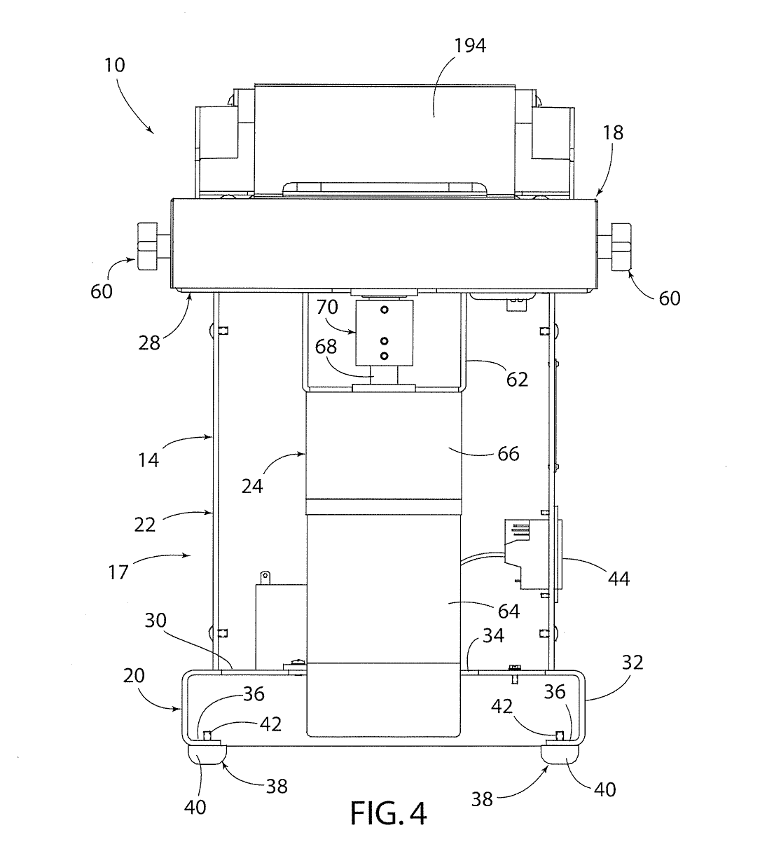

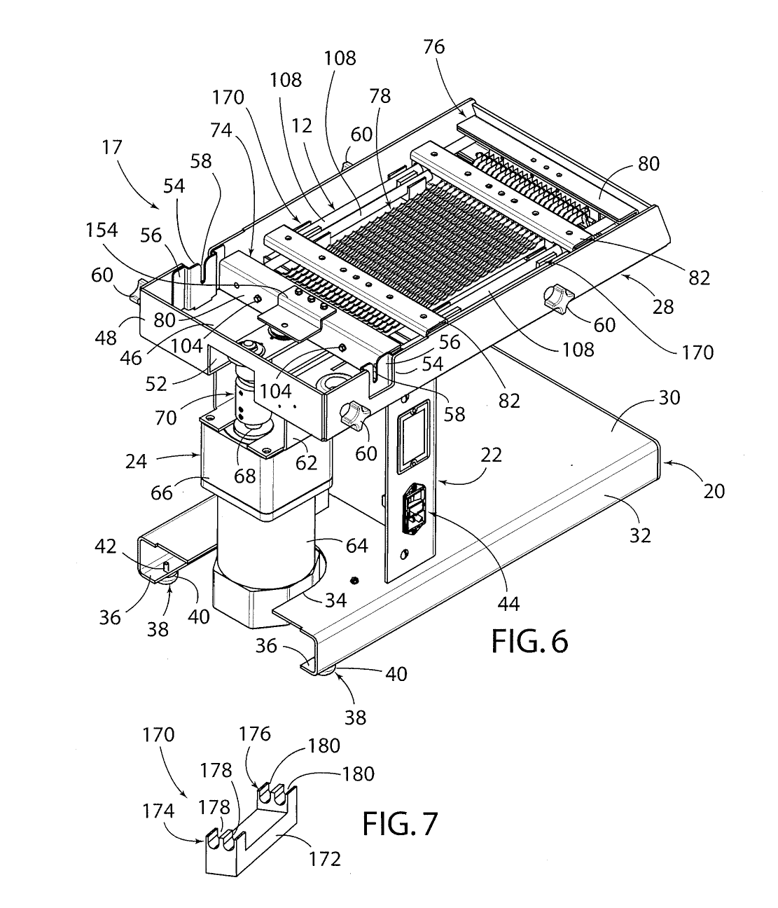

The illustrated base 17 supports the remainder of the slicer 10 on a table or other surface. The base 17 includes a plate 30 having a skirt 32 extending downward from a front and sides of the plate 30. As illustrated in FIG. 6, the plate 30 has an arch-shaped slot 34 in a rear end therefore for accepting the motor assembly 24 therein. The base 17 includes a pair of bottom flanges 36 (see FIG. 4) having feet 38 connected thereto. The feet 38 include pads 40 on a bottom thereof for supporting the feet 38 and the base 17 on a substantially flat surface. The feet 38 can be fixed to the bottom flanges 36 (or any other portion of the base) or can be vertically adjustable relative to the bottom flanges 36 (or any other portion of the base). For example, the feet 38 can include a threaded post 42 extending from a top of the pad 40, with the threaded post 42 being adjustably received within a threaded opening (not shown) in the bottom flanges 36. The feet 38 can therefore be rotatable and vertically adjustable relative to the bottom flanges 36. It is contemplated that the pads 40 could be directly connected to a bottom of the plate 30 without including any skirt 32. The column 22 extends upward from a top surface of the plate 30.

In the illustrated example, the column 22 connects the platform 28 to the pedestal 20. The column 22 is C-shaped and includes an electrical receiver 44 for accepting a power cord (not shown). It is contemplated that the slicer 10 could include an on-off toggle switch and, if so, that the on-off toggle switch would be located on the column 22. It is also contemplated that the power supply could be routed into the slicer 10 through the pedestal 20, the platform 28 or any other portion of the housing 14. The column 22 extends upward from the top of the plate 30 and supports the pedestal 20. The column 22 is also configured to be connected to the motor cover 26 so as to cover the motor assembly 24. In the illustrated example, the pedestal 20, the column 22 and the platform 28 are integral. However, it is contemplated that the pedestal 20, the column 22 and the platform 28 could comprise separate parts (e.g., the pedestal 20 could be a table top, the column 22 could be a wall and the platform 28 could extend from the wall in a cantilever fashion).

The illustrated platform 28 is connected to the column 22 and is configured to receive the cutting blade assembly 12 and the cover 18. The platform 28 comprises a bottom plate 46 connected to a top of the column 22. The platform 28 also includes a substantially rectangular side wall 48 extending upwardly from the bottom plate 46. The bottom plate 46 includes a central opening 50. As discussed in more detail below, the bread product falls through the central opening 50 after the bread product is sliced by the cutting blade assembly 12. The side wall 48 includes a pair of aligned slots 54 located behind the column 22. A pair of U-shaped handle connection members 56 extend inwardly from the slots 54 in the side wall 48 and are connected to the side wall 48 on either side of the slots 54. Each U-shaped handle connection member 56 includes a top opening channel 58 for receiving a portion of the pusher handle 16, as discussed in more detail below. The platform 28 includes a plurality of screw connectors 60 for connecting the cover 18 to the platform 28. The bottom plate 46 and a rear of the side wall 48 include an L-shaped slot 52 for allowing a portion of the motor assembly 24 to engage the cutting blade assembly 12. A motor support member 62 extends downward from a bottom of the bottom plate 46 and surrounds the L-shaped slot 52.

In the illustrated example, the motor assembly 24 is connected to the platform 28 and causes the cutting blade assembly 12 to slice the bread product. The motor assembly 24 includes an electric motor 64 receiving power from the power cord via the electrical receiver 44 in the column 22 and a cord between the electrical receiver 44 and the electric motor 64. A transmission housing 66 is connected to an output of the electric motor 64. The transmission housing 66 includes gears (not shown) connected to the output of the electric motor 64 and an output shaft 68. The transmission housing 66 is used to reposition the rotary output of the electric motor 64. An output assembly 70 connects to the output shaft 68. As discussed in more detail below, the output assembly 70 is configured to move the cutting blade assembly 12. As illustrated in FIGS. 4 and 6, the electric motor 64 extends through the arch-shaped slot 34 in the plate 30 of the platform 28. A top of the transmission housing 66 is connected to a bottom of the motor support member 62 to retain the motor assembly 24 within the base 17. The motor cover 26 is U-shaped and covers an area between a bottom of the bottom plate 46 of the platform 28 and a top of the plate 30 of the pedestal 20 by engaging with the column 22. The motor cover 26 includes a bottom lip 72 forming a rear wall of the pedestal 20. The motor assembly 24 causes the cutting blade assembly 12 to slice the bread product.

The illustrated cutting blade assembly 12 slices the bread product. The cutting blade assembly 12 includes a first slider assembly 74 and a second slider assembly 76 with the first slider assembly 74 and the second slider assembly 76 each including a plurality of cutting blades 78. The first slider assembly 74 and the second slider assembly 76 are configured to move linearly and in a reciprocal motion to allow the cutting blades 78 to slice the bread product. The first slider assembly 74 and the second slider assembly 76 are substantially similar such that the first slider assembly 74 will be discussed below, with the understanding that the second slider assembly 76 is similarly structured.

The illustrated first slider assembly 74 of the cutting blade assembly 12 includes the plurality of cutting blades 78 extending between and connected to a closed end member 80 and an open end member 82. As illustrated in FIG. 11, each cutting blade 78 includes a central cutting portion 84 and a pair of enlarged ends 86. Each enlarged end 86 of the cutting blade 78 includes a pin opening 88 adapted to receive a first connecting pin 90 or a second connecting pin 91. The closed end member 80 includes the first connecting pin 90 and the open end member 82 includes a plurality of the second connecting pins 91. The first connecting pin 90 and the second connecting pins 91 allow the closed end member 80 and the open end member 82 to retain the cutting blades 78.

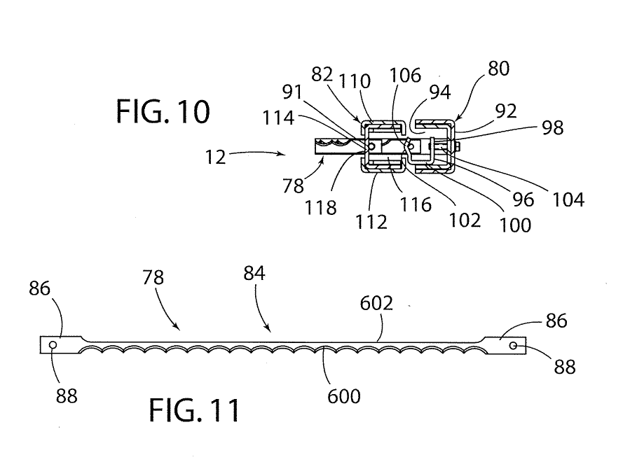

In the illustrated example, the closed end member 80 includes a double walled C-shaped housing 92 having an opening 94 facing towards a center of the first slider assembly 74. A pin holding member 96 is located within the opening 94. The pin holding member 96 includes a back wall 98, a bottom wall 100 and a front wall 102. A plurality of connection members 104 (e.g., screws) extend through the double walled C-shaped housing 92 and into the back wall 98 of the pin holding member 96 to connect the pin holding member 96 to the double walled C-shaped housing 92. The front wall 102 of the pin holding member 96 includes an arcuate portion 106 having a plurality of substantially parallel slots therein. As illustrated in FIG. 10, one of the enlarged ends 86 of each cutting blade 78 of the first slider assembly 74 extends through one of the slots in the arcuate portion 106 of the pin holding member 96. The first connecting pin 90 abuts a rear of the arcuate portion 106 of the pin holding member 96 and extends through the pin openings 88 of the enlarged ends 86 of the cutting blades 78. The arcuate portion 106 of the pin holding member 96 can be flexible to bias the first connecting pin 90 towards the rear of the opening 94 of the double walled C-shaped housing 92. Furthermore, the connection members 104 can be adjustable to move the pin holding member 96 to adjust the tension of the cutting blades 78 held by the first connecting pin 90. Therefore, the pin holding member 96 maintains the cutting blades 78 taut within the first slide assembly 74. A pair of sliding rods 108 are fixed to the double walled C-shaped housing 92 on opposite sides of the pin holding member 96 and the cutting blades 78. The pair of sliding rods 108 connect the closed end member 80 to the open end member 82.

The illustrated open end member 82 of the first slider assembly 74 includes a top plate 110, a bottom plate 112 and a C-shaped connection member 114 extending between the top plate 110 and the bottom plate 112. The C-shaped connection member 114 has an opening 116 facing toward the closed end member 80. The C-shaped connection member 114 includes a front wall 118 having a plurality of slots extending therethrough. The cutting blades 78 of the first slider assembly 74 extend through every other slot in the front wall 118 of the C-shaped connection member 114. Each second connecting pin 91 abuts a rear of the front wall 118 of the C-shaped connection member 114 and extends through a second end of one of the cutting blades 78. Every slot in the front wall 118 of the C-shaped connection member 114 not having a cutting blade 78 of the first slider assembly 74 extending therethrough includes a cutting blade 78 of the second slider assembly 76 extending therethrough (and vice versa). The sliding rods 108 are also connected to the C-shaped connection member 114 on opposite sides of the cutting blades 78. The C-shaped connection member 114 also includes bearing tubes 120 located to a side of the sliding rods 108. The bearing tubes 120 are configured to accept sliding rods 108 of the second slider assembly 76 therethrough.

In the illustrated example, the first slider assembly 74 and the second slider assembly 76 move linearly and in a reciprocal motion to allow the cutting blades 78 to slice the bread product. The sliding rods 108 of the first slider assembly 74 slide through the bearing tubes 120 of the open end member 82 of the second slider assembly 76 and the sliding rods 108 of the second slider assembly 76 slide through bearing tubes 120 of the open end member 82 of the first slider assembly 74.

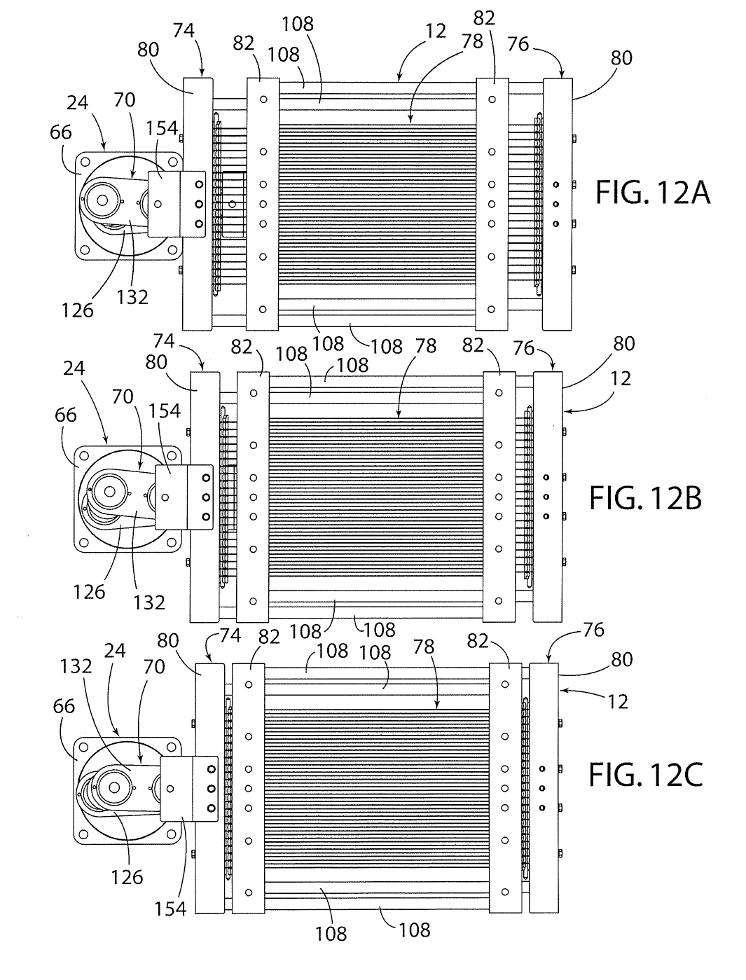

FIGS. 12A-12C illustrate the sliding movement of the first slider assembly 74 relative to the second slider assembly 76. FIG. 12A illustrates the first slider assembly 74 and the second slider assembly 76 in a fully extending position. As illustrated in FIG. 12A, the closed end member 80 of the first slider assembly 74 is moved away from the open end member 82 of the second slider assembly 76. Accordingly, the sliding rods 108 of the first slider assembly 74 and the second slider assembly 76 move the open end member 82 of the first slide assembly 74 away from the closed end member 80 of the second slider assembly 76. FIG. 12B illustrates the first slider assembly 74 and the second slider assembly 76 as the closed end member 80 of the first slider assembly 74 is moved towards the open end member 82 of the second slider assembly 76. Accordingly, the sliding rods 108 of the first slider assembly 74 and the second slider assembly 76 move the open end member 82 of the first slide assembly 74 towards the closed end member 80 of the second slider assembly 76. Furthermore, the sliding rods 108 of the first slider assembly 74 will slide through the bearing tubes 120 of the second slider assembly 76 and the sliding rods 108 of the second slider assembly 76 will slide through the bearing tubes 120 of the first slider assembly 74. Moreover, the cutting blades 78 of the first slider assembly 74 will slide through the slots extending through the front wall 118 of the C-shaped connection member 114 of the open end member 82 of the second slider assembly 76 and the cutting blades 78 of the second slider assembly 76 will slide through the slots extending through the front wall 118 of the C-shaped connection member 114 of the open end member 82 of the first slider assembly 74. Therefore, the cutting blades 78 of the first slider assembly 74 and the cutting blades 78 of the second slider assembly 76 will reciprocate relative to each other. FIG. 12C illustrates the first slider assembly 74 and the second slider assembly 76 as the closed end member 80 of the first slider assembly 74 is adjacent the open end member 82 of the second slider assembly 76. At the point illustrated in FIG. 12C, the closed end member 80 of the first slider assembly 74 will thereafter move away from the open end member 82 of the second slider assembly 76 and towards the position as illustrated in FIG. 12A.

In the illustrated example, the first slider assembly 74 and the second slider assembly 76 move in a linear and reciprocating fashion to slice the bread product. The first slider assembly 74 and the second slider assembly 76 could be actuated using many manners. One method of actuating the first slider assembly 74 and the second slider assembly 76 is to use motor assembly 24 and the output assembly 70. The output assembly 70 is located between the output shaft 68 of the transmission housing 66 and the cutting blade assembly 12.

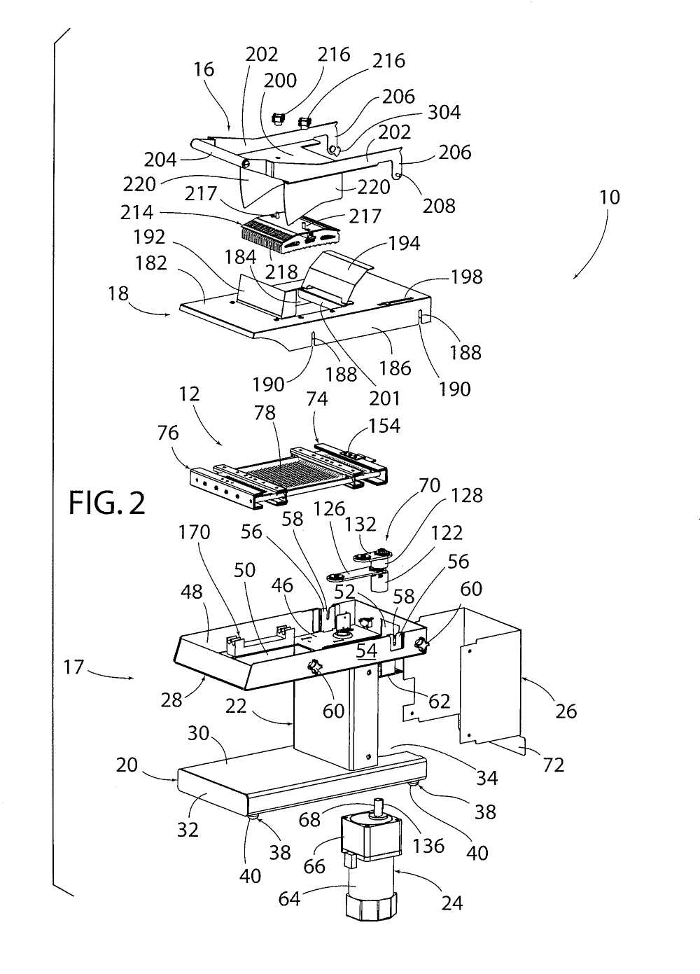

As illustrated in FIGS. 2, 12A-12C, 21, 21A and 23, the output assembly 70 includes a first gear 122, a first pin 124, a first connection bar 126, a second gear 128, a second pin 130 and a second connection bar 132. The first gear 122 includes a bottom aperture 134 configured to accept the output shaft 68 of the transmission housing 66 therein. The output shaft 68 can include a spline 136 and the bottom aperture 134 can include a channel 138, with the spline 136 of the output shaft 68 being inserted into the channel 138 of the bottom aperture 134 to ensure that the first gear 122 rotates with the output shaft 68. The first pin 124 is inserted into a top aperture 140 in the first gear 122. The top aperture 140 is off center and the first pin 124 can be fixed relative to the first gear 122 or can rotate relative to the first gear 122. The first connection bar 126 is elongate and includes a first end opening 142 and a second end opening 144. The first connection bar 126 is connected to the first pin 124 by inserting the first pin 124 through the first end opening 142. As discussed in more detail below, the second end opening 144 interacts with the second slider assembly 76 to move the second slider assembly 76. The second gear 128 includes a first hole 146 accepting the first pin 124 therein and a second hole 148 accepting the second pin 130 therein. The first hole 146 and the second hole 148 are off center and located along a diametrical line. Both the first pin 124 and the second pin 130 can be allowed to rotate freely within the second gear 128. However, it is contemplated that both the first pin 124 and the second pin 130 are fixed in position within the second gear 128, but the first pin 124 is allowed to freely rotate within the first gear 122. The second connection bar 132 is elongate but shorter than the first connection bar 126 and includes a first end opening 150 and a second end opening 152. The second connection bar 132 is connected to the second pin 130 by inserting the second pin 130 through the first end opening 150. As discussed in more detail below, the second end opening 152 interacts with the first slider assembly 74 to move the first slider assembly 74.

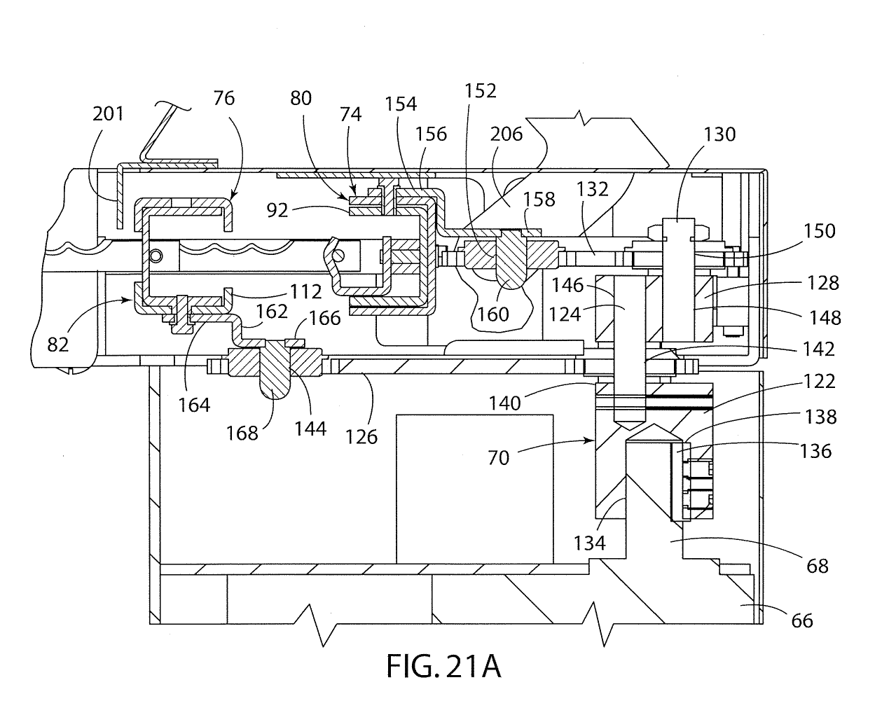

In the illustrated example, the output assembly 70 moves the cutting blade assembly 12. As illustrated in FIG. 21A, the double walled C-shaped housing 92 of the closed end member 80 of the first slider assembly 74 includes a first double bent connection member 154 connected to a top thereof. The first double bent connection member 154 includes a first top member 156 attached to a top of the double walled C-shaped housing 92 and a first bottom member 158 including a first downwardly depending shaft 160. The first downwardly depending shaft 160 is configured to be inserted into the second end opening 152 of the second connection bar 132 to connect the first slider assembly 74 to the output assembly 70. Likewise, the bottom plate 112 of the open end member 82 of the second slider assembly 76 includes a second double bent connection member 162 connected to a bottom thereof. The second double bent connection member 162 includes a second top member 164 attached to a bottom of the bottom plate 112 and a second bottom member 166 including a second downwardly depending shaft 168. The second downwardly depending shaft 168 is configured to be inserted into the second end opening 144 of the first connection bar 126 to connect the second slider assembly 76 to the output assembly 70.

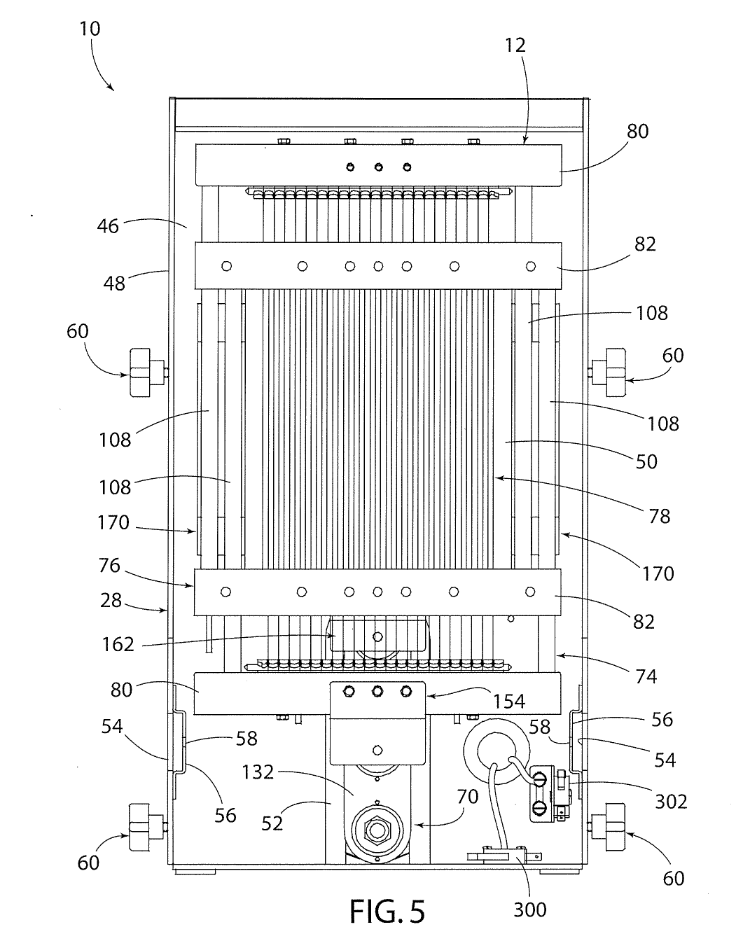

The illustrated cutting blade assembly 12 is configured to be removably inserted into the housing 14. As illustrated in FIGS. 2, 5 and 6, the platform 28 of the base 17 includes a pair of slider blocks 170 on opposite sides of the central opening 50 in the bottom plate 46 of the platform 28. Each slider block 170 (see FIG. 7) includes a foot 172, a first end wedge 174 and a second end wedge 176. The first end wedge 174 includes a pair of first sliding rod grooves 178 and the second end wedge 176 includes a pair of second sliding rod grooves 180. The pair of first sliding rod grooves 178 are aligned with the pair of second sliding rod grooves 180. As the cutting blade assembly 12 is inserted into the housing 14, the sliding rods 108 of the first slider assembly 74 and the second slider assembly 76 are inserted into the first sliding rod grooves 178 and the pair of second sliding rod grooves 180 (see FIG. 5). It is contemplated that the pair of first sliding rod grooves 178 and the pair of second sliding rod grooves 180 of the slider blocks 170 could be concave such that the sliding rods 108 snap fit into the pair of first sliding rod grooves 178 and the pair of second sliding rod grooves 180 of the slider blocks 170. Furthermore, the first downwardly depending shaft 160 is inserted into the second end opening 152 of the second connection bar 132 and the second downwardly depending shaft 168 is inserted into the second end opening 144 of the first connection bar 126.

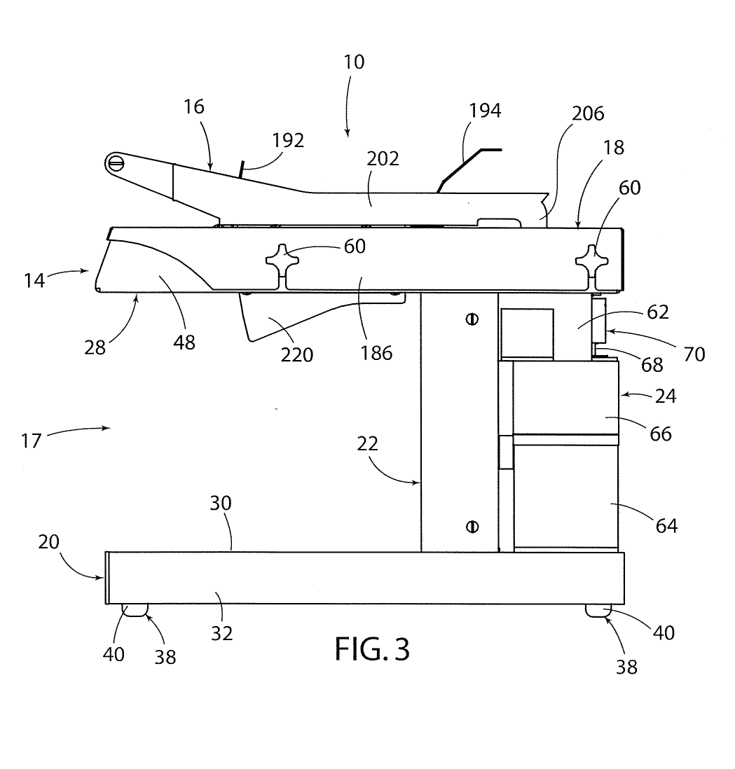

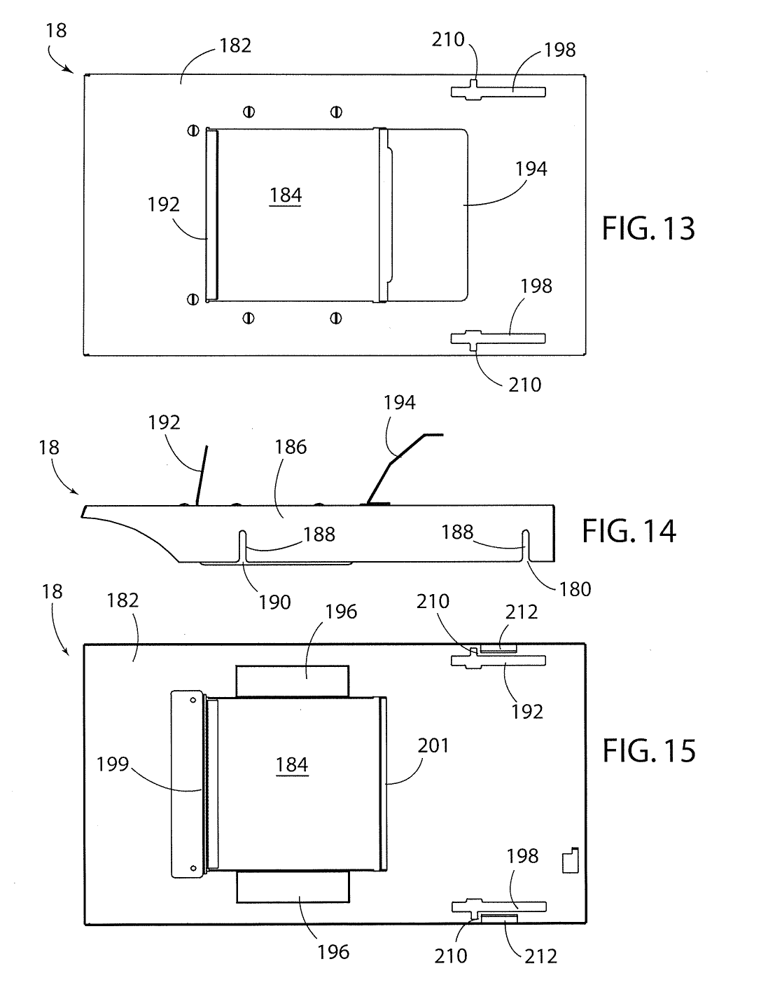

In the illustrated example, the cover 18 (FIGS. 13-15) covers the cutting blade assembly 12 within the platform 28 of the housing 14. The cover 18 includes a top panel 182 having a central opening 184 and a substantially rectangular skirt 186 extending downwardly from a periphery of the top panel 182. The cover 18 is configured to be positioned over the platform 28 of the housing 14, with the skirt 186 of the cover 18 enveloping the side wall 48 of the platform 28 (see FIGS. 1, 3 and 4). The skirt 186 of the cover 18 includes a plurality of connector slots 188 in a side surface thereof with the connector slots 188 each having a lower mouth 190 being configured to receive the screw connectors 60 of the platform 28. Therefore, once the cover 18 is properly positioned over the platform 28, the screw connectors 60 can be tightened (by rotation) to maintain the cover on the platform 28. Once the cover 18 is properly positioned on the platform 28, the central opening 184 in the top panel 182 of the cover 18 will be generally aligned with the central opening 50 of the bottom plate 46 of the platform 28. Accordingly, as discussed in more detail below, the bread product can be placed through the central opening 184 in the top panel 182 of the cover 18, become sliced with the cutting blade assembly 12 and fall through the central opening 50 of the bottom plate 46 of the platform 28. The cover 18 also includes a front guard 192 extending upwardly in front of the central opening 184 of the top panel 182 and a rear guard 194 extending upwardly behind the central opening 184 of the top panel 182. The cover 18 also includes a comb-shaped member 199 having a plurality of slots in front of the central opening 184 extending downwardly from a bottom surface of the top panel 182 and a rear guard 201 behind the central opening 184 extending downwardly from the bottom surface of the top panel 182. The front comb-shaped member 199 covers a top of the blades 78 and allows the blades 78 to slide though the slots thereof. The front comb-shaped member 199 and the rear guard 201 extending downwardly adjacent the central opening 184 prevents the bread product being sliced from moving too far forward or too far rearward during the slicing process. It is contemplated that the front comb-shaped member 199 can be made of any material (e.g., metal or plastic).

As illustrated in FIG. 15, a pair of slider block closure blocks 196 are located on opposite sides on the central opening 184 on a bottom of the top panel 182. The slider block closure blocks 196 enclose and cover the pair of first sliding rod grooves 178 and the pair of second sliding rod grooves 180 of the slider blocks 170 when the cover 18 is engaged with the platform 28 to maintain the sliding rods 108 of the first slider assembly 74 and the second slider assembly 76 within the pair of first sliding rod grooves 178 and the pair of second sliding rod grooves 180 of the slider blocks 170. The top panel 182 of the cover 18 also includes a pair of handle slots 198 configured to accept a portion of the pusher handle 16 therethrough.

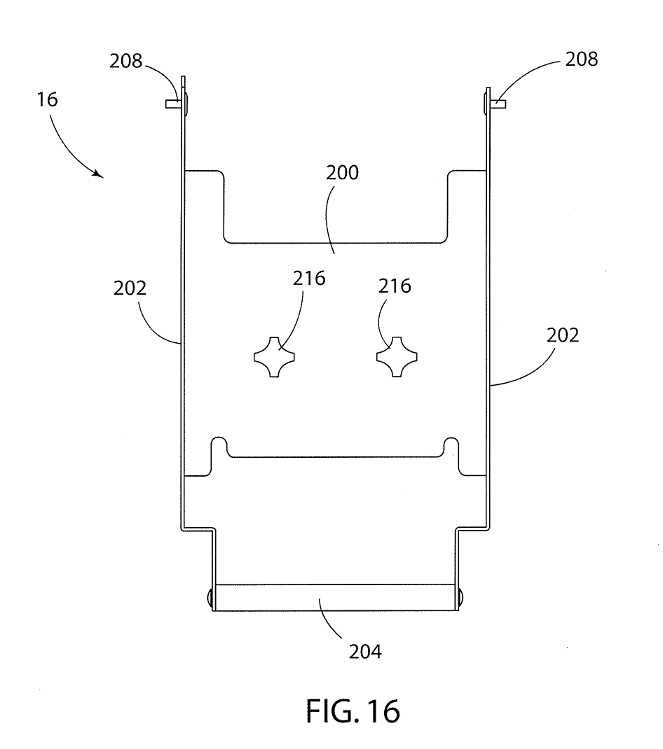

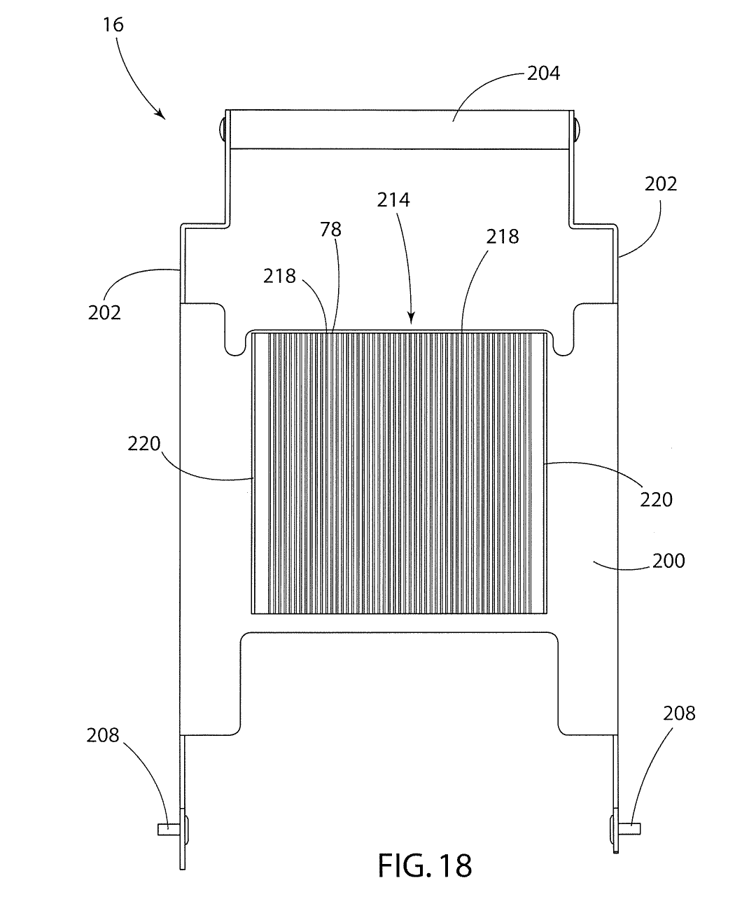

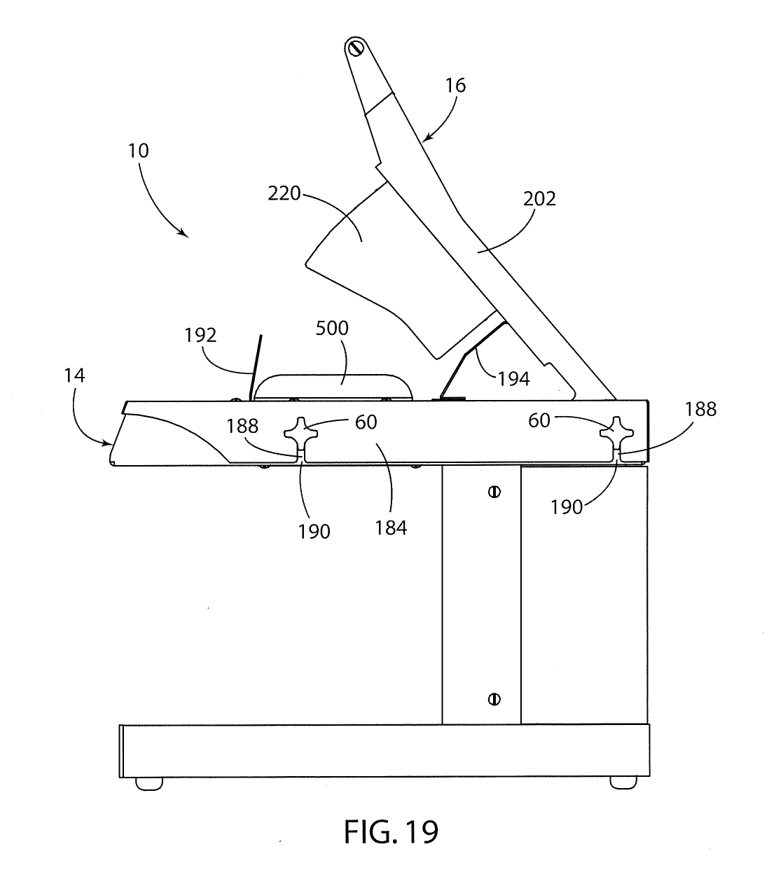

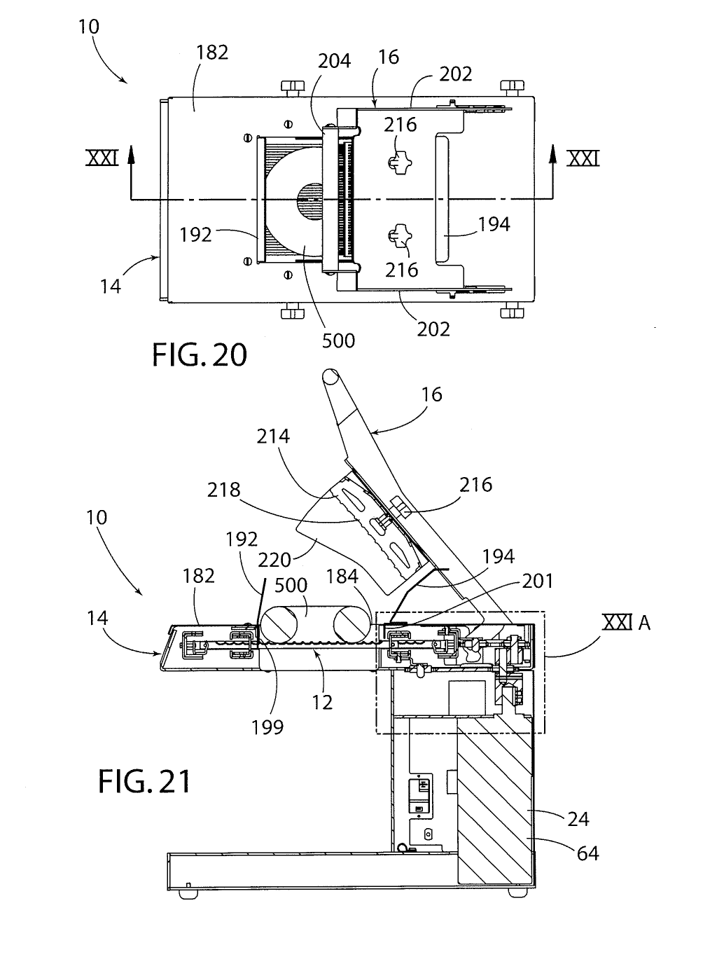

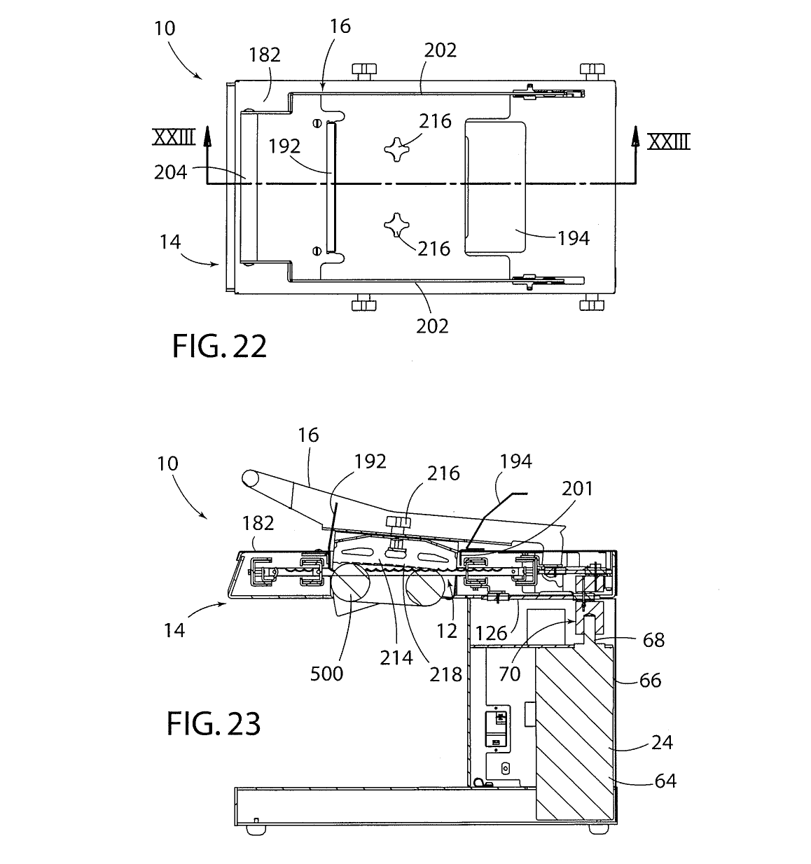

The illustrated pusher handle 16 (FIGS. 16-18) is used to push the bread product through the central opening 184 in the top panel 182 of the cover 18, through the cutting blade assembly 12 to slice the bread product and through the central opening 50 of the bottom plate 46 of the platform 28. The pusher handle 16 includes a main plate 200 having a pair of side members 202 connected thereto. A grip 204 extends between and is connected to a first end of the side members 202. A pair of ears 206 having outwardly extending pivot pins 208 extend downwardly from a second end of the side members 202 (see FIG. 2). As illustrated in FIG. 15, the handle slots 198 of the cover 18 each include a pin niche 210 for accepting the pivot pins 208 as the ears 206 are positioned through the handle slots 198. The cover 18 also includes a pivot pin housing 212 configured to accept the pivot pins 208 of the pusher handle 16 to connect the pusher handle 16 to the cover 18. As the cover 18 and the pusher handle 16 are positioned over the platform 28 of the housing 14, the pivot pins 208 of the ears 206 of the pusher handle 16 slide into the top opening channels 58 in the handle connection member 56. Therefore, the pusher handle 16 can pivot about the pivot pins 208 between a load position as illustrated in FIGS. 19-21 and a cutting position as illustrated in FIGS. 1 and 22 and 23.

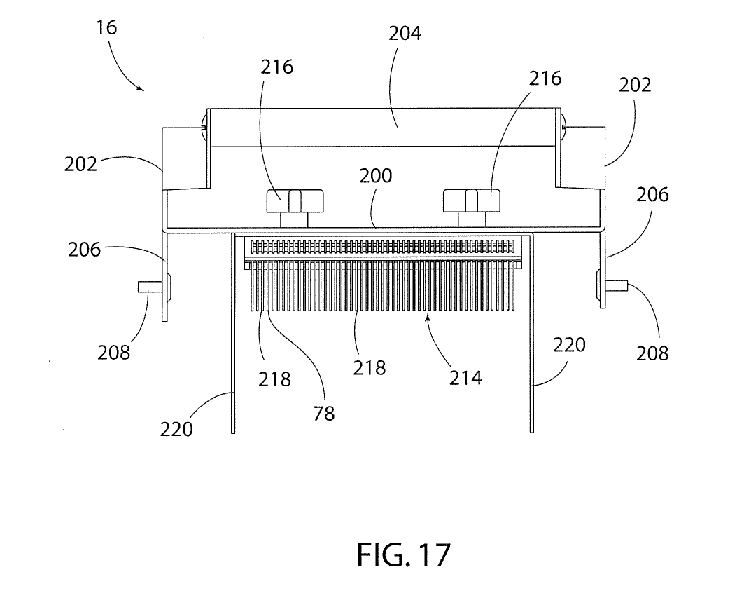

In the illustrated example, a pusher member 214 is connected to a bottom of the main plate 200 of the pusher handle 16 for pushing the bread product through the cutting blade assembly 12. The pusher member 214 can be removably connected to the main plate 200 by removably inserting screw members 217 (see FIG. 2) extending upwardly from the pusher member 214 through the main plate 200 and into a pair of nut connectors 216. The pusher member 214 includes a plurality of pushing fins 218 extending downwardly therefrom. The pushing fins 218 have a thickness smaller than but substantially equal to a distance between adjacent cutting blades 78 in the cutting blade assembly 12. Therefore, the pushing fins 218 can push the bread product through the cutting blade assembly 12 as the pusher handle 16 is moved to the cutting position. As illustrated in FIGS. 17 and 19, the pusher handle 16 includes a pair of side shields 220 on either side of the pusher member 214 for enclosing an area above the cutting blades 78 while the bread product is being sliced.

The illustrated slicer 10 is used to slice a bread product. Initially, the pusher handle 16 is moved to the load position as illustrated in FIGS. 19-21 (typically using the grip 204 of the pusher handle 16) by pivoting the pusher handle 16 about the pivot pins 208. As the pusher handle 16 is being raised, an area for insertion of the bread product (shown as a bagel 500 in FIGS. 19-23) is opened. Once the pusher handle 16 is in the load position, the bread product can be placed into the insertion area as illustrated in FIGS. 19-21. Thereafter, the pusher handle 16 is moved towards the cutting position as illustrated in FIGS. 1 and 22 and 23 by rotating the pusher handle 16 (typically using the grip 204) about the pivot pins 208 in a direction opposite to the direction that the pusher handle 16 was rotated to move the pusher handle 16 to the load position (counter-clockwise as shown in FIGS. 19-23). In the illustrated example, the motor assembly 24 will not actuate to move the cutting blades 78 of the cutting blade assembly 12 until at least one of two switches is actuated. First, the platform 28 can include a first switch 300 (see FIG. 5) that is activated once the cover 18 is properly positioned onto the platform 28. Second, the platform 28 can include a second switch 302 (see FIG. 5) that is activated when a projection 304 (see FIG. 2) on one of the ears 206 of the side members 202 of the pusher handle 16 engages with the second switch 302. In the illustrated example, the second switch 302 is activated when the pusher handle 16 is rotated to a position where a bottom of the pushing fins 218 of the pusher member 214 is located behind and below a top of the front guard 192 of the cover 18. Therefore, the motor assembly 24 will not actuate to move the cutting blades 78 of the cutting blade assembly 12 until the insertion area is enclosed and covered by the front guard 192 and the pushing fins 218 at a front thereof, the rear guard 194 at a rear thereof and the side shields 220 of the pusher handle 16 at sides thereof. However, it is contemplated that the slicer 10 could be activated continuously, with a button or with other switches. Nevertheless, it is contemplated that the slicer 10 would include the first switch 300 and the second switch 302 (or some other configuration wherein the cutting blades 78 would only move when the insertion area is enclosed) for safety reasons. As the pusher handle 16 is moved to the final cutting position as illustrated in FIGS. 1 and 22 and 23, the pushing fins 218 of the pusher member 214 will push the bagel 500 through the cutting blade assembly 12 to slice the bagel 500 using the cutting blades 78. The pushing fins 218 can extend between the cutting blades 78 to fully push the bread product through the cutting blade assembly 12.

In the illustrated example, the motor assembly 24 is activated as the bread product is being pushed through the cutting blade assembly 12. As the motor assembly 24 is activated, the electric motor 64 begins rotating its output shaft in the transmission housing 66 to rotate the output shaft 68 of the transmission housing 66. As the output shaft rotates, the first gear 122, the first pin 124, the second gear 128 and the second pin 130 of the output assembly 70 begin to move as outlined above. As the first pin 124 revolves with the first gear 122 and the second gear 128, the first connection bar 126 will move with the first pin 124 and move the second end opening 144 of the first connection bar 126 in a linear manner. Furthermore, as the second pin 130 revolves with the second gear 128, the second connection bar 132 will move with the second pin 130 and move the second end opening 152 of the second connection bar 132 in a linear manner. In the illustrated example, movement of the first connection bar 126 and the second connection bar 132 are out of phase by 180° such that when the second end opening 144 of the first connection bar 126 is closest to the cutting blade assembly 12, the second end opening 152 of the second connection bar 132 is farthest from the cutting blade assembly 12 and vice versa. Moreover, as the second end opening 144 of the first connection bar 126 and the second end opening 152 of the second connection bar 132 move, the first downwardly depending shaft 160 of the first double bent connection member 154 and the second downwardly depending shaft 168 of the second double bent connection member 162 will move to move the first slider assembly 74 and the second slider assembly 76 as discussed above to move the cutting blades 78 to slice the bread product.

The illustrated cutting blades 78 can be made of any material (e.g., metal or ceramic). For example, it is contemplated that the cutting blades 78 can be made of high carbon chrome vanadium steel. The cutting blades 78 can be made from a coil stock of material having an initial rectangular cross section. Therefore, the cutting blades 78 can be cut to size and can be cut to have cutting teeth 600 (see FIG. 11) on a top side of the central cutting portion 84 and a recessed portion 602 of a bottom side of the central cutting portion 84. Forming the cutting teeth 600 and the recessed portion 602 of the central cutting portion 84 can thereby form the enlarged ends 86 of the cutting blade 78 (i.e., the enlarged ends 86 can be large because portions to the side of the ends 86 have been made smaller). Alternatively, the ends 86 can be formed larger than the rest of the cutting blade 78 in other fashions (e.g., the enlarged ends 86 can be large because they are made larger). The cutting blades 78 include enlarged ends 86 to allow for enough material surrounding the pin openings 88 to prevent fracture of the cutting blades 78 surrounding the pin openings 88 (via tension force from the first connection pin 90 (being biased by the pin holding member 96) and the second connection pin 91). Furthermore, the recessed portion 602 prevents an area of the cutting blades 78 below the cutting teeth 600 from tearing the bread product via friction as the bread product moves past the cutting blades 78. If the cutting blades 78 have too great a height, the cutting blades will tear the bread product via friction as the bread product moves past the cutting blades 78. It is also contemplated that that the cutting teeth 600 can be ground deeper (thereby extending the depth of the cutting teeth 600) instead of having the recessed portion 602 or in conjunction with the recessed portion 602 to reduce the friction of the cutting blades 78 against the bread product. However, it is contemplated that the size of the enlarged ends 86 of the cutting blades 78 are a function of the material and thickness of the cutting blades 78. As the material of the cutting blades 78 becomes stronger and as the thickness of the cutting blades 78 becomes thicker, the size of the ends 86 of the cutting blades 78 relative to the remainder of the cutting blades 78 can decrease. However, it is contemplated that the cutting blades 78 do not want to be too thick so as to efficiently slice the bread product without tearing the bread product. In the illustrated example, the cutting blades 78 can have a thickness of about 0.0149-0.0162 inches. However, the cutting blades 78 can be thicker or thinner. Furthermore, in the illustrated example, the height of the cutting blades in the central cutting portion 84 can be about 0.25 inches. However, the height of the cutting blades in the central cutting portion 84 can be more or less than 0.25 inches. For example, an embodiment of the cutting blade 78 can have a thickness of about 0.0149-0.0162 inches, a height of the central cutting portion 84 of about 0.25 inches, a height of the enlarged ends of about 0.375 inches and a total length of about 10.8 inches. Furthermore, the distance between each cutting blade 78 can be any desired distance. For example, the cutting blades 78 can be about 0.125 inches apart (or narrower or wider). If the cutting blades 78 are about 0.125 inches apart, the resulting chip will have a thickness at its greatest extent of less than about 0.125 inches. Moreover, with the slicer 10 as described above, the slices in the bread product are made simultaneously.

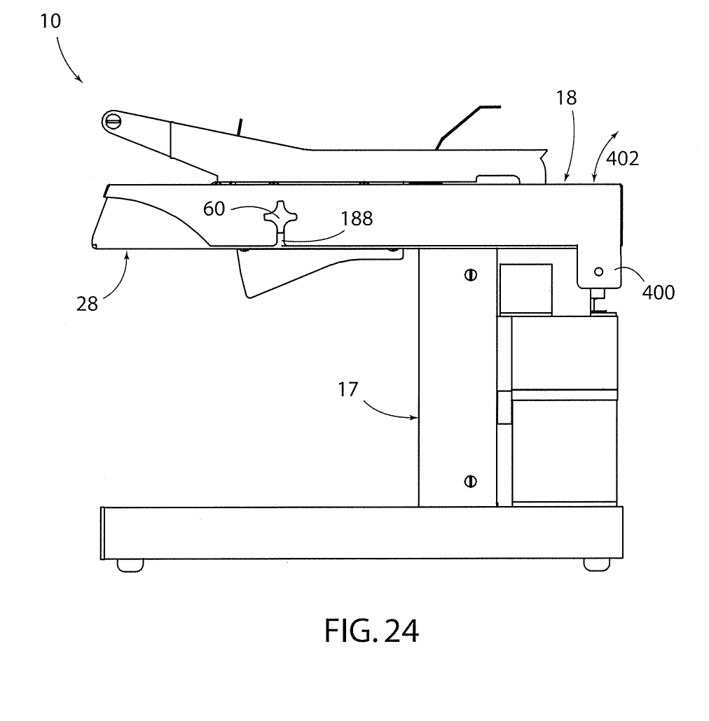

FIGS. 24-32 illustrate alternative features for the slicer 10. Any of the features shown in FIGS. 24-32 or discussed below can be used with the slicer 10 discussed above or can be used in any combination (i.e., each feature can be used with the slicer 10 one at a time or any combination of any of the features can be used with the slicer 10).

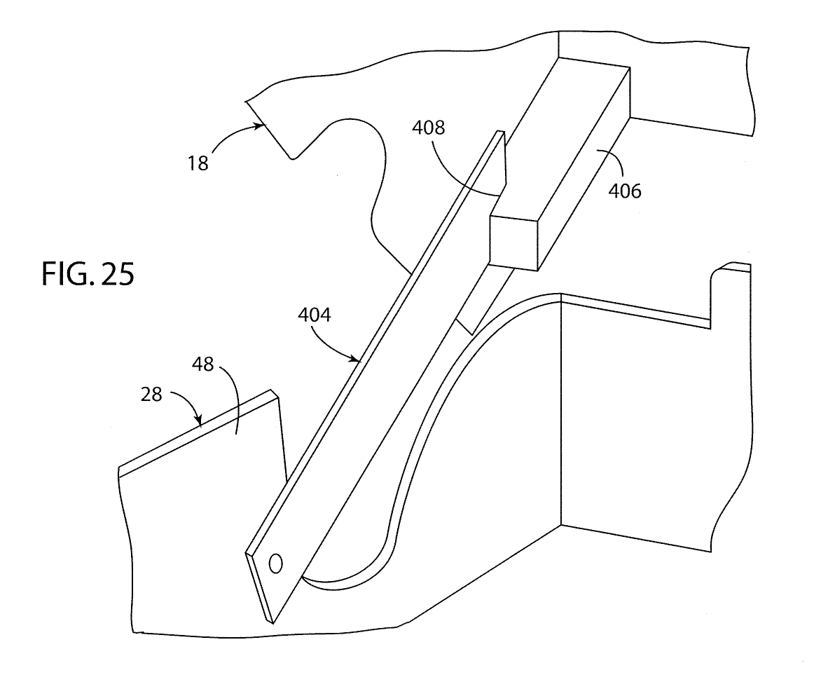

FIGS. 24-25 illustrate another manner of connecting the cover 18 to the platform 28 of the base 17. As illustrated in FIG. 24, the cover 18 can have a pair of downwardly depending ears 400 at a rear thereof, with each ear 400 being pivotally connected to the platform 28. Therefore, the cover 18 can pivot relative to the platform 28 along line 402. With the cover 18 being pivotally connected to the platform 28, the connection slots 188 on either side of the cover 18 can be arcuate to allow the connection slots 188 to easily side along the screw connectors 60. As illustrated in FIG. 25, the platform 28 can include at least one pivoting stay member 404 for maintaining the cover 18 in a rotated position. The stay member 404 can be pivotally connected to the side wall 48 of the platform 28. In use, after the cover 18 is pivoted to an open position, the stay member 404 can be pivoted upward to abut a block 406 connected to an inside surface of the cover 18. The stay member 304 can include a cut out portion 408 for engagement with the block 406. In order to close the cover 18, the cover 18 is rotated to an further open position, the stay member 404 is rotated downward, and the cover 18 is rotated back to the closed position. It is contemplated that the platform 28 can include a pair of stay members 404, with each stay member 404 being located at a rear side of the side walls 48 of the platform 28.

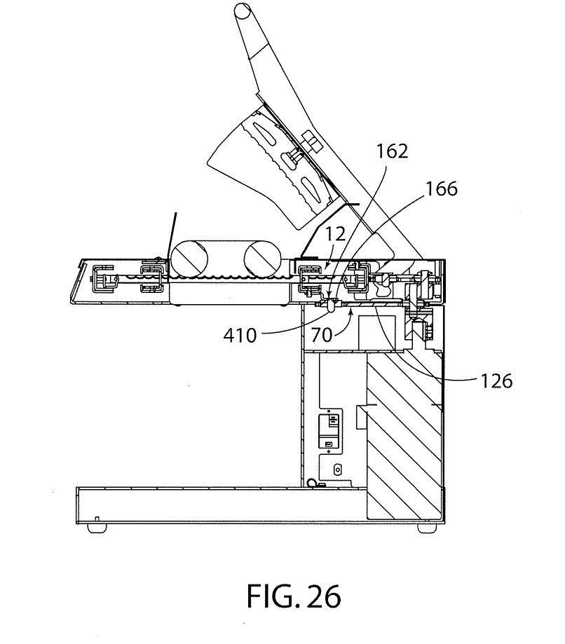

FIG. 26 is a cross section view of the slicer 10 illustrating a connection between the cutting blade assembly 12 and the output assembly 70. As shown in FIG. 26, instead of a second shaft 168 for an interface between the second bottom member 166 of the second double bend connection member 162 and the first connection bar 126 of the output assembly 70, a spherical bearing 410 is used.

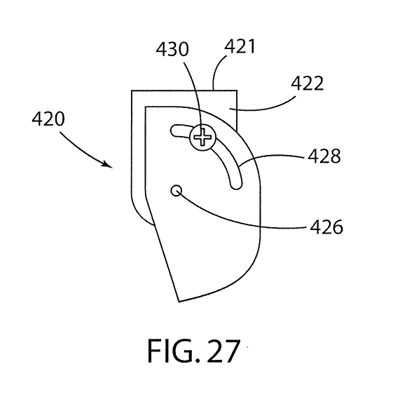

FIG. 27 illustrates a cam 420 for actuating the first switch 300 as discussed above for allowing the slicer 10 to operate once the cover 18 is placed in the closed position. The cam 420 depends downwardly from a bottom surface of the top panel 182 of the cover 18. The cam 420 includes a first plate 422 fixedly connected to the bottom surface of the top panel 182 at a top edge 421 thereof. The cam 420 also includes a second plate 424 pivotally connected to the first plate 422 at a pivot point 426. The second plate 424 includes an arcuate slot 428 therein along with a screw member 430 extending through the arcuate slot 428 and into the first plate 422. The screw member 430 is configured to be loosened to allow the second plate 424 to pivot relative to the first plate 422. As the second plate 424 is pivoting relative to the first plate 422, the screw member 430 will slide through the arcuate slot 428. Once the second plate 424 is in a proper position, the screw member 430 is tightened to maintain the second plate 424 is position relative to the first plate 422. The first plate 422 and the second plate 424 allow adjustment of the cam 420 relative to the first switch 300 to ensure that the cam 420 engages with the first switch 300 when the cover 18 is placed in the closed position. It is contemplated that the first plate 422 and the second plate 424 can have any periphery (e.g., a non-rectangular periphery).

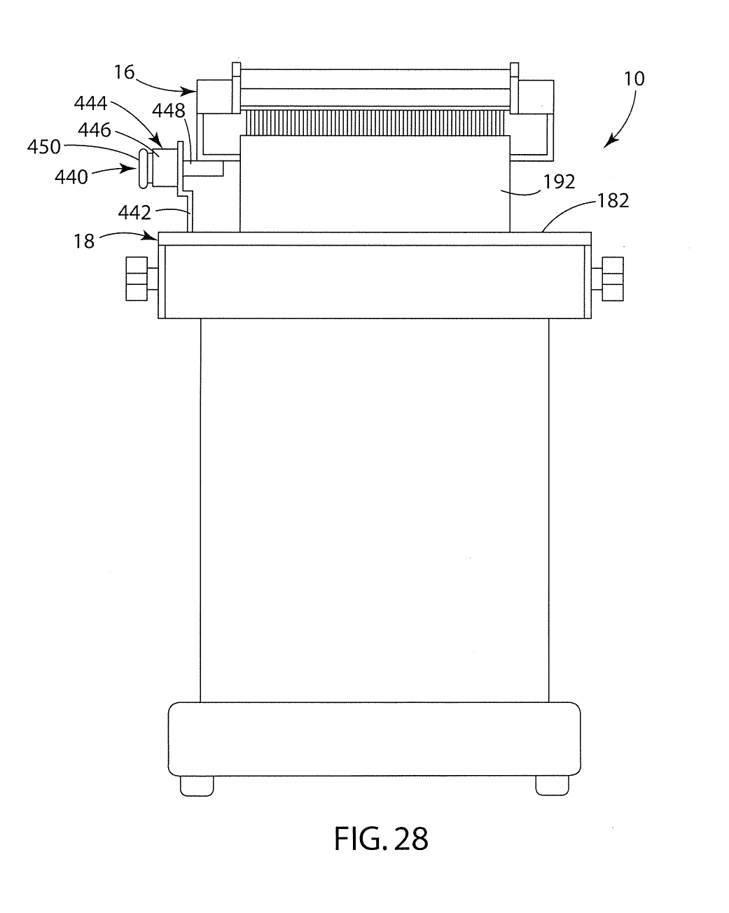

FIG. 28 illustrates a stop member 440 for halting pivotal movement of the pusher handle 16. The stop member 440 is configured to stop the pushing fins 218 of the pusher member 214 from extending between the cutting blades 78. The stop member 440 includes a support member 442 extending upwardly from a top surface of the top panel 182 of the cover 18. A pin assembly 444 is connected to the support member 442 and includes spring housing 446 connected to one side of the support member 442. A pin member 448 extends through the spring housing 446 and the support member 442. A spring in the spring housing 446 biases the pin member 448 towards the right as illustrated in FIG. 28. A handle 450 on a left side of the spring housing 446 is connected to the pin member 448. Pulling the handle 450 to the left as illustrated in FIG. 28 will move the pin member 448 to the left against the bias of the spring in the spring housing 446. During use, the bread product is pushed through the cutting blade assembly 12 as described above, but the pin member 448 of the stop member 440 prevents rotation of the pusher handle 16 downward past a point wherein the pushing fins 218 of the pusher member 214 would extend between the cutting blades 78. The bread product between the cutting blades 78 can be past the cutting blades 78 by rotating the pusher handle 16 upward and placing a further bread product in the slicer 10. Once the bread product to be sliced is exhausted, the handle 450 of the stop member 440 is pulled to move the pin member 448 out of the path of the pusher handle 16 to allow the pusher handle 16 to fully rotate downward, thereby allowing the pushing fins 218 to extend between the cutting blades 78 to push the final bread product through the cutting blade assembly 12.

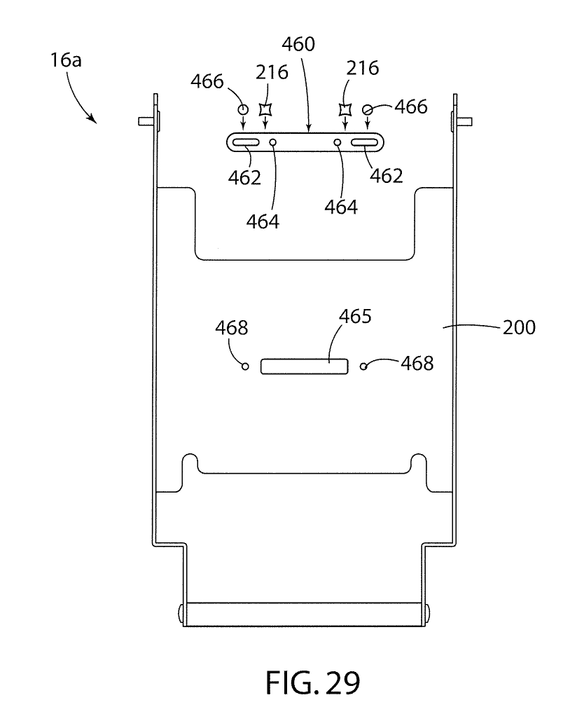

FIG. 29 is a top view of a modified pusher handle 16a of the present invention. In the modified pusher handle 16a, instead of having the nut connectors 216 extending directly through the main plate 200, the nut connectors 216 extend through a connection panel 460 connected to the main plate 200. The connection panel 460 includes a pair of side slots 462 and a pair of inner holes 464. The nut connectors 216 extend through the inner holes 464, through an aperture 465 in the main plate 200 and into the pusher member 214. Fasteners 466 extend through the side slots 462 and into openings 468 in the main plate 200. The position of the connection panel 460 is adjustable in a lateral direction by sliding the connection panel 460 relative to the fasteners 466 (which would slide through the side slots 462 in the connection panel 460). The connection panel 460 and movement thereof allows for adjustment of the pusher member 214 to align with the spaces between the blades 78 to ensure that the pushing fins 218 of the pusher member 214 can properly extend between the cutting blades 78.

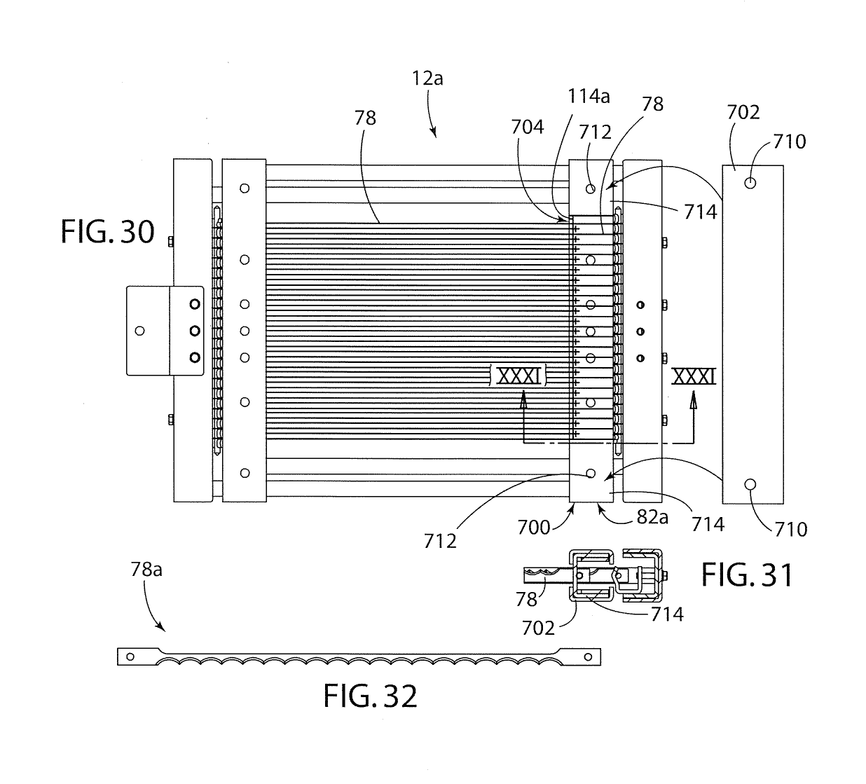

FIGS. 30 and 31 illustrate a modified cutting blade assembly 12a having a modified open end member 82a having a bottom member 700 and a top member 702. The modified open end member 82a allows for easier assembly of the cutting blade assembly 12a. With the open end member 82 described above, the cutting blades 78 must be threaded through the slots in the front wall 118 of the C-shaped connection member 114. In the modified open end member 82a, the connection member 114a is L-shaped in a middle portion 704 thereof and the cutting blades 78 can be slid into the top open ended slots in the connection member 114a from a top of the cutting blade assembly 12a. After all of the cutting blades 78 are positioned into the top open ended slots in the connection member 114a from a top of the cutting blade assembly 12a, the top member 702 is positioned over the bottom member 700 and fasteners are inserted through holes 710 in ends of the top member 702 and holes 712 in top end portions 714 of the bottom member 700.

FIG. 32 illustrates a modified cutting blade 78a that does not include a recessed portion 602. The cutting blades 78a do not have a recessed portion 602 if the cutting blades 78a are located a certain distance apart or greater. For example, it is contemplated that the cutting blades 78a without the recessed portion 602 could be used if the cutting blades 78a are more than 3/16″ apart. Moreover, it is contemplated that short pins could extend though each pin openings 88 in the cutting blades 78 or 78a, with each individual short pin being associated with only one pin opening 88 instead of a long pin extending through a plurality of pin openings 88 in a plurality of cutting blades 78 or 78 (e.g., replacing a long pin extending through the pin openings 88 in a plurality of cutting blades 78 and abutting the arcuate portion 106 of the pin holding member 96 with a plurality of short pins extending through the pin openings 88 in a plurality of cutting blades 78 and abutting the arcuate portion 106 of the pin holding member 96).

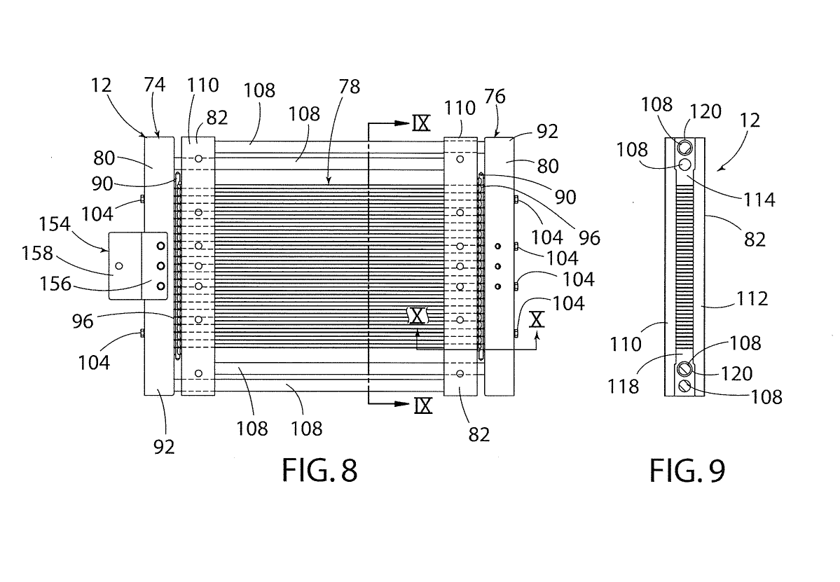

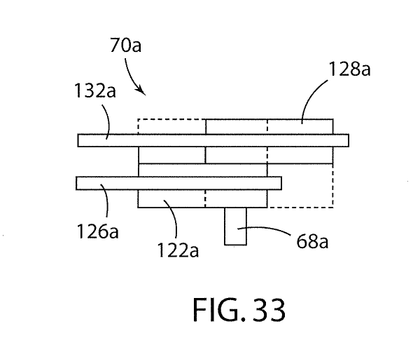

The reference numeral 70a (FIG. 33) generally designates another embodiment of the present invention, having a second embodiment for the output assembly. Since output assembly 70a is similar to the previously described output assembly 70, similar parts appearing in FIGS. 1-32 and FIG. 33, respectively, are represented by the same, corresponding reference number, except for the suffix “a” in the numerals of the latter. The second embodiment of the output assembly 70a functions in the same manner as the previously described output assembly 70. The second embodiment of the output assembly 70a comprises a pair of offset discs including a bottom disc 122a fixedly connected to the output shaft 68a and a top disc 128a fixedly connected to the bottom disc 122a in an offset manner. The bottom disc 122a and the top disc 128a rotate about an axis co-linear with the axis of rotation of the output shaft 68a. The first connection bar 126a includes an opening accepting the bottom disc 122a therein and the second connection bar 132a includes an opening accepting the top disc 128a therein.

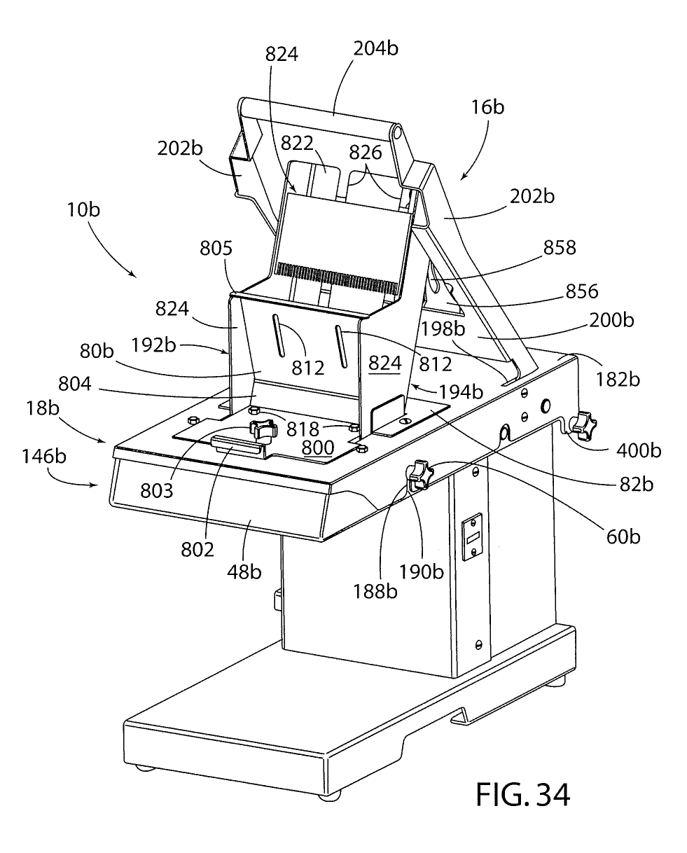

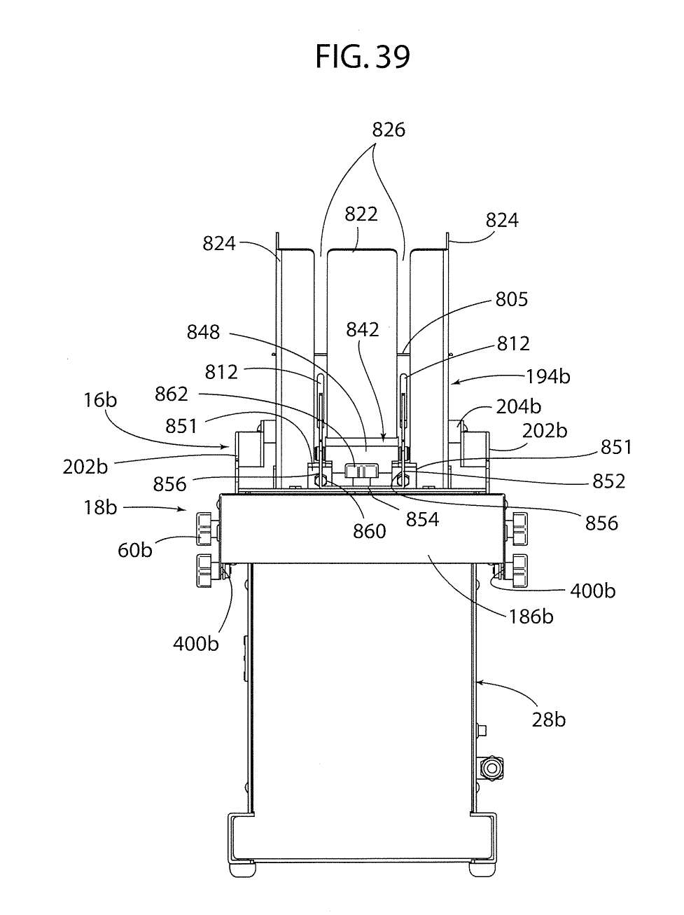

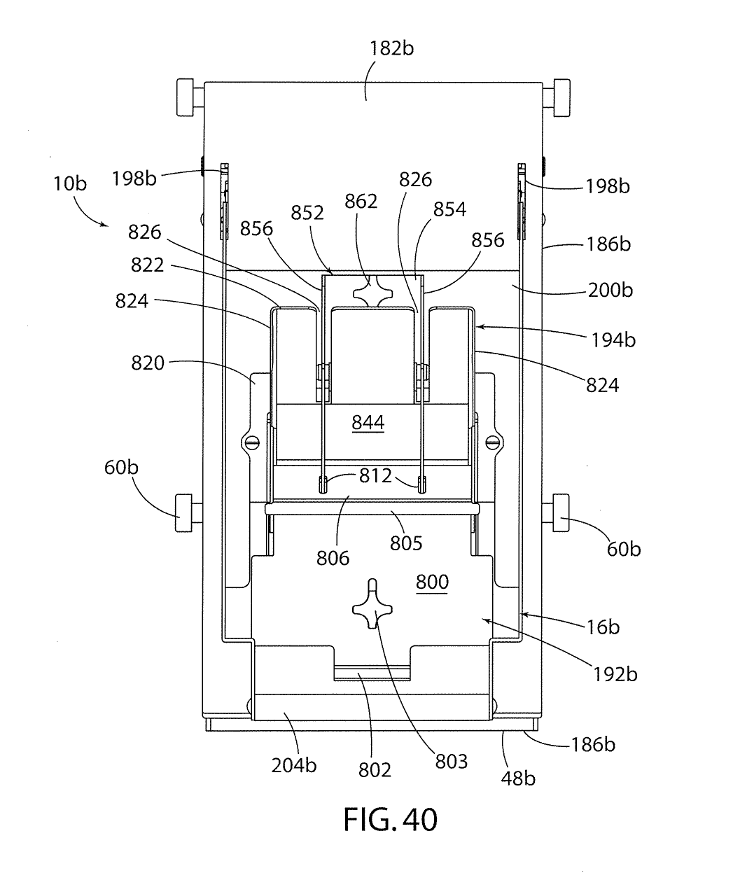

The reference numeral 10b (FIGS. 34-41) generally designates another embodiment of the present invention, having a third embodiment for the slicer. Since slicer 10b is similar to the previously described slicer 10, similar parts appearing in FIGS. 1-32 and FIGS. 34-41, respectively, are represented by the same, corresponding reference number, except for the suffix “b” in the numerals of the latter. The third embodiment of the slicer 10b functions in substantially the same manner as the previously described slicer 10. The third embodiment of the slicer 10b can be used to slice the bread product into chips wherein the cutting blades 78b are spaced at 0.25 inches or less. The third embodiment of the slicer 10b includes a cover 18b connected to a base 17b and a pusher handle 16b connected to the cover 18b.

In the illustrated example, the cover 18b covers the cutting blade assembly 12b within the platform 28b of the housing 14b. The cover 18b includes a top panel 182b having a central opening 184b and a substantially rectangular skirt 186b extending downwardly from a periphery of the top panel 182b. The cover 18b is configured to be positioned over the platform 28b of the housing 14b, with the skirt 186b of the cover 18b enveloping the side wall 48b of the platform 28b (see FIGS. 34 and 36-40). The skirt 186b of the cover 18b includes a plurality of connector slots 188b in a side surface thereof with the connector slots 188b each having a lower mouth 190b being configured to receive screw connectors 60b of the platform 28b. The cover 18b can have a pair of downwardly depending ears 400b at a rear thereof, with each ear 400b being pivotally connected to the platform 28b. Therefore, the cover 18b can pivot relative to the platform 28b. With the cover 18b being pivotally connected to the platform 28b, the connection slots 188b on either side of the cover 18b can be arcuate to allow the connection slots 188b to easily side along the screw connectors 60b. The platform 28b can include at least one pivoting stay member for maintaining the cover 18b in a rotated position as discussed above in regard to FIG. 25. The cover 18b and the platform 28b can also include a cam 420b as discussed above in regard to FIG. 27.

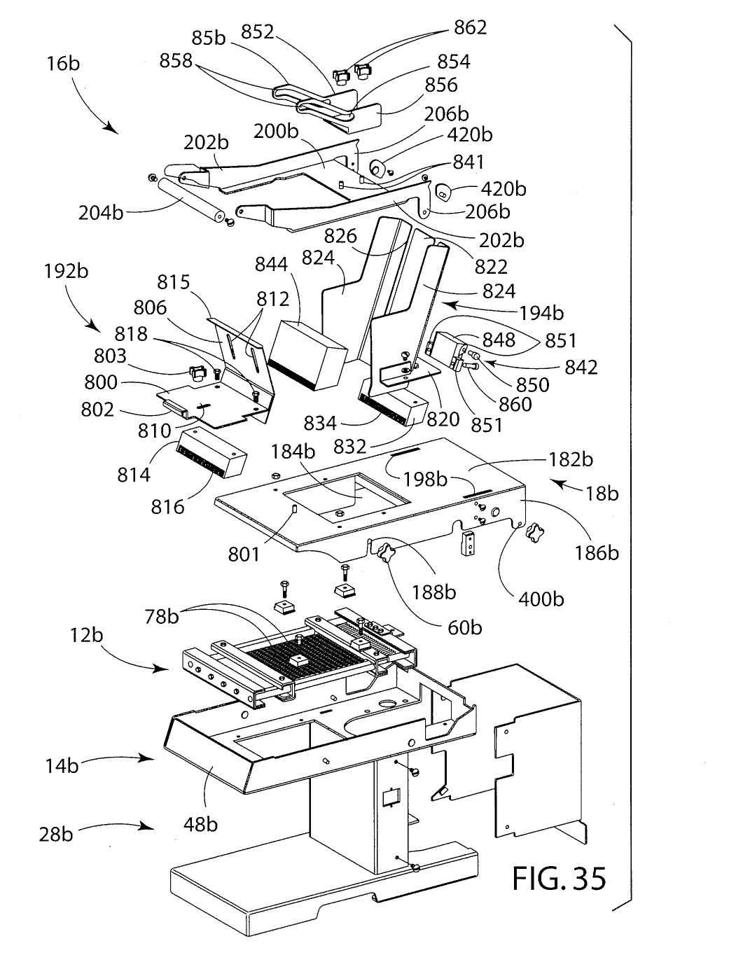

The illustrated cover 18b also includes a front guard 192b in front of the central opening 184b of the top panel 182b and a rear guard 194b behind the central opening 184b of the top panel 182b. The front guard 192b includes a base portion 800, a first angled portion 804 at an end of the base portion 800 and a second angled portion 806 at a top of the first angled portion 804. The base portion 800 includes a connector slot 810 configured to receive a screw post 801 extending upwardly from a top of the top panel 182b. The screw post 801 is inserted through the connector slot 810 and a nut connector 803 is connected to the screw post 801 to secure the base portion 800 of the front guard 192b to the top panel 182b. The base portion 800 includes a front hook 802 at a front end thereof. The front hook 802 can be grasped to slide the base portion 800 along the connector slot 810 to properly align the front guard 192b. It is contemplated that the front hook 802 could be excluded from the front guard 192b, that the connector slot 810 is circular and that the base portion 800 is not configured to slide on the top panel 182b. The first angled portion 804 is located at a rear edge of the base portion 800 at a midpoint of the first angled portion 804 such that a top of the first angled portion 804 is angled rearward (see FIG. 35). The top of the first angled portion 804 is located at a bottom of the second angled portion 806, with the second angled portion 806 being angled in a direction opposite to the angled direction of the first angled portion 804. The second angled portion 806 includes a top lip 805 and a pair of handle slots 812, which will be discussed in more detail below. The front guard 192b also includes a front block 814 having a plurality of blade slots 816 connected to a bottom of the base portion 800 by connectors 818. When the front guard 192b is connected to the cover 18b, a bottom of the first angled portion 804 and the front block 814 will be located below the top panel 182b of the cover 18b. The blade slots 816 are configured to accept the cutting blades 78b therein for allowing the cutting blades 78b to reciprocate as discussed above. The front guard 192a covers a front of the central opening 184b above the top panel 182b of the cover 18b to prevent access to the cutting blades 78b (except for the bread product as discussed below) and to prevent the bread product from moving too far forward while being cut in the same manner as the comb-shaped member 199 as discussed above. It is contemplated that instead of the front block 814, the front guard 192b could include a metal comb like member (similar to the comb-shaped member 199 discussed above) depending downwardly from the first angled portion 804 and into the central opening 184b at a front thereof.

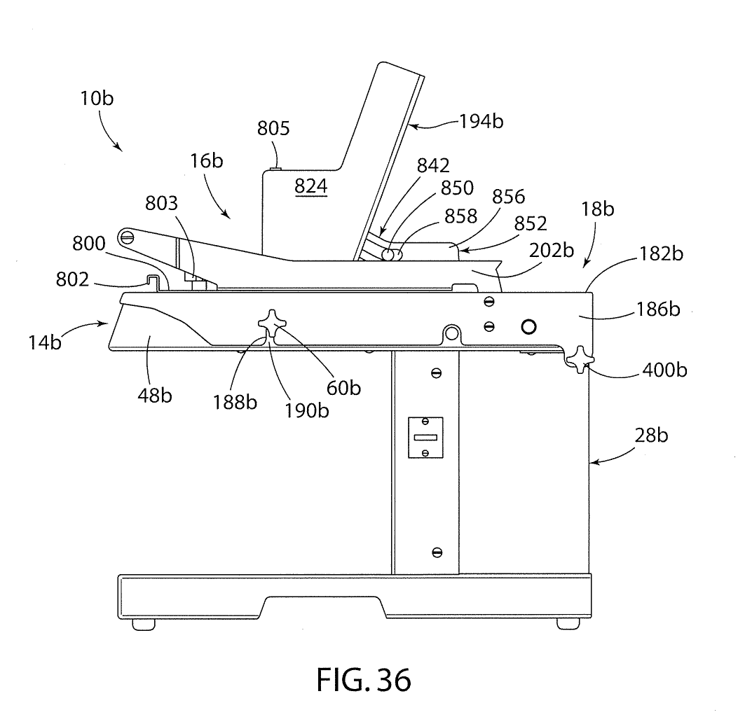

In the illustrated rear guard 194b protects a rear of the central opening 184b in the top panel 182b of the cover 18b. The rear guard 194b includes a base plate 820, a rear guide plate 822 and a pair of side guide plates 824. The base plate 820 is U-shaped and includes a pair of openings for accepting fasteners therethrough for connecting the base plate 820 to the top panel 182b of the cover 18b. The rear guide plate 822 and the pair of side guide plates 824 are joined to form a U-shaped structure, with the rear guide plate 822 and the pair of side guide plates 824 connected to an inside edge of the base plate 820. The rear guard 194b also includes a rear block 832 having a plurality of blade slots 834 connected to a bottom of the base plate 820 by connectors. When the rear guard 194b is connected to the cover 18b, a bottom of rear guide plate 822, the pair of side guide plates 824 and the rear block 832 will be located below the top panel 182b of the cover 18b. The blade slots 834 are configured to accept the cutting blades 78b therein for allowing the cutting blades 78b to reciprocate as discussed above. The rear guard 194a covers a rear and sides of the central opening 184b above the top panel 182b of the cover 18b to prevent access to the cutting blades 78b (except for the bread product as discussed below) and to prevent the bread product from moving too far rearward while being cut in the same manner as the rear guard 201 as discussed above. As illustrated in FIGS. 36-38 and 40, the top lip 805 of the second angled portion 806 of the front guard 192b rests on a top the pair of side guide plates 824. It is contemplated that instead of the rear block 832, the rear guard 194b could include a metal comb like member (similar to the comb-shaped member 199 discussed above) depending downwardly from the rear guide plate 822 and into the central opening 184b at a rear thereof. The front guard 192b and the rear guard 194b form a substantially rectangular enclosure for accepting the bread product therein. The handle 16b is employed to push the bread product through the substantially rectangular enclosure formed by the front guard 192b and the rear guard 194b and through the cutting blade assembly 12b.

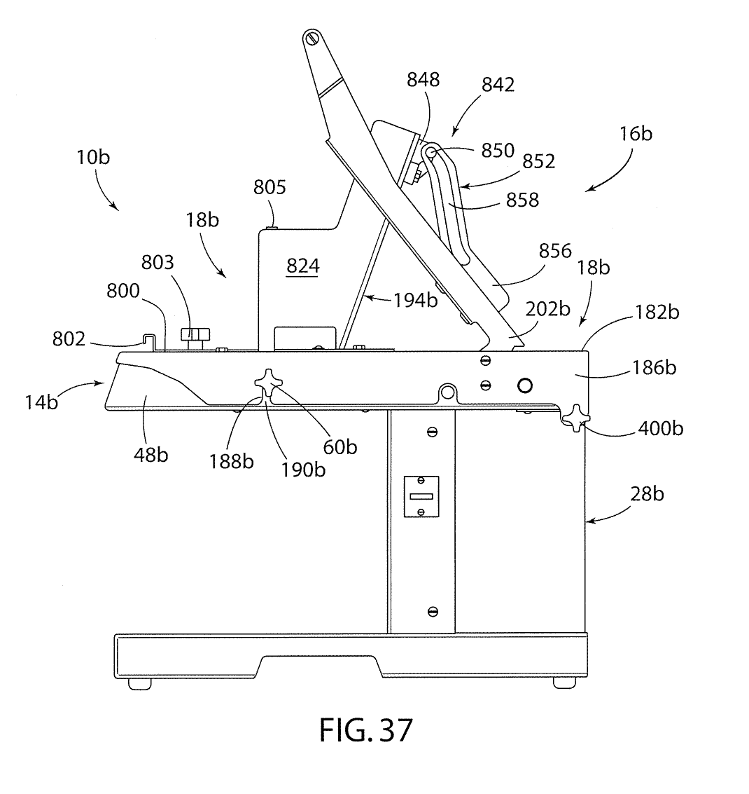

In the illustrated example, the pusher handle 16b is used to push the bread product through the central opening 184b in the top panel 182b of the cover 18b and through the cutting blade assembly 12b to slice the bread product. The pusher handle 16b includes a main plate 200b having a pair of side members 202b connected thereto. A grip 204b extends between and is connected to a first end of the side members 202b. A pair of ears 206b extend downwardly from a second end of the side members 202b. As illustrated in FIG. 35, the cover 18b includes handle slots 198b for accepting the ears 206 therethrough. The pusher handle 16b can pivot about pivot pins between a load position as illustrated in FIG. 37 and a cutting position as illustrated in FIG. 36.

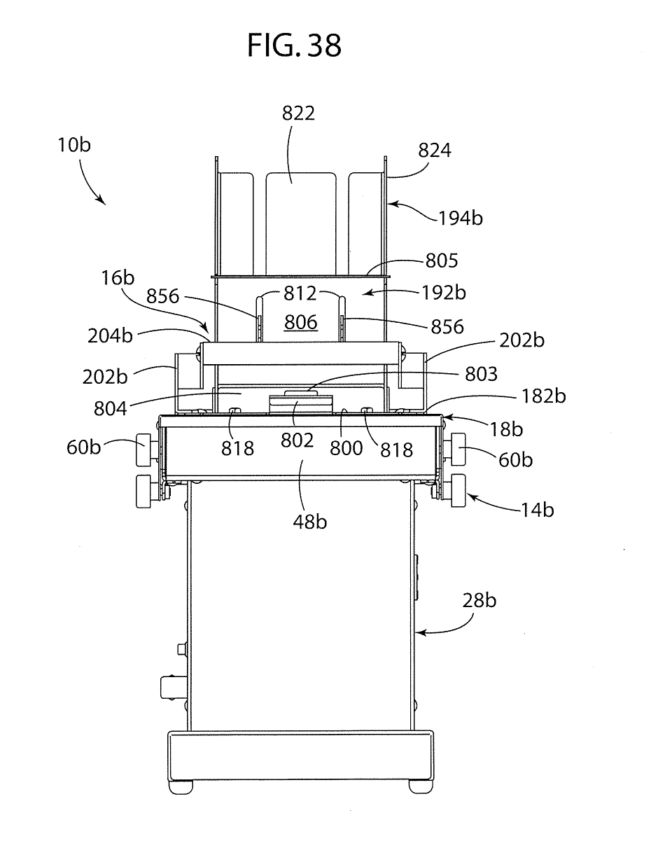

The illustrated pusher handle 16b includes a pusher block assembly 842 for pushing the bread product through the central opening 184b in the top panel 182b of the cover 18b and through the cutting blade assembly 12b to slice the bread product. The pusher block assembly 842 includes a pusher block 844, a guide block 848 and a slider linkage 852. The slider linkage 852 interconnects the pusher block 844 to the guide block 848. The slider linkage 852 is also engaged with the main plate 200b of the pusher handle 16b to move the pusher block assembly 842 with movement of the rest of the pusher handle 16b. The slider linkage 852 comprises a base panel 854 having a pair of openings and a pair of side panels 856. The pair of side panels 856 extend upwardly from opposite ends of the base panel 854 and are substantially parallel. The pair of side panels 856 each include slots 858 therein. The slider linkage 852 is connected to the main plate 200b by inserting connector pins 841 on the main plate 200b through the openings in the base panel 854. Nut connectors 862 are threaded onto the connector pins 841 to fixedly connect the slider linkage 852 to the main plate 200b. As illustrated in FIGS. 38-40, the side panels 856 of the slider linkage 852 slide through handle slots 826 in the rear guide plate 822 of the rear guard 194b. The slider linkage 852 moves the pusher block 844 to push the bread product through the cutting blade assembly 12b.

In the illustrated example, the pusher block 844 is connected to the guide block 848. The guide block 848 is abuts a rear face of the rear guide plate 822 of the rear guide 194a. The guide block 848 includes a pair of side wings 851. Block connector pins 860 extend through the side wings 851, through the handle slots 826 in the rear guide plate 822 of the rear guide 194a and into the pusher block 844. Therefore, the pusher block 844 abuts a front face of the rear guide plate 822 of the rear guide 194a and slides with the guide block 848. The guide block 848 also includes a pair of co-linear slide pins 850 extending outwardly from opposite sides thereof. As illustrated in FIGS. 37 and 38, the slide pins 850 slide within the slots 858 of the pair of side panels 856 of the slider linkage 852. Therefore, as illustrated in FIG. 36, the slide pins 850 are located in a rear of the slots 858 of the pair of side panels 856 of the slider linkage 852 when the handle 16b is in the cutting position. As the handle 16b is lifted to the load position as illustrated in FIG. 37, the slide pins 850 will slide forwardly within the slots 858 of the pair of side panels 856 of the slider linkage 852 to thereby lift the guide block 848 via the slide pins 850 and to thereby lift the pusher block 844 via the block connector pins 840. As the handle 16b is pushed downward back to the cutting position, the slide pins 850 is be forced rearward within the slots 858 of the pair of side panels 856 of the slider linkage 852 to thereby push the guide block 848 and the pusher block 844 downward to thereby push the bread product within the substantially rectangular enclosure formed by the front guard 192b and the rear guard 194b and through the cutting blade assembly 12b. Front ends of the side panels 856 of the slider linkage 852 can also extend through the handle slots 812 as illustrated in FIG. 38. It is contemplated that the rear face of the rear guide plate 822 of the rear guide 194a could include at least one vertically aligned guide projection and that a front face of the guide block 848 could include at least one corresponding guide slot, with the projection fitting into the slot to assist the guide block 848 is sliding in a vertical and aligned direction along the rear face of the rear guide plate 822 of the rear guide 194a as the handle 16b is pulled up and pushed downward.

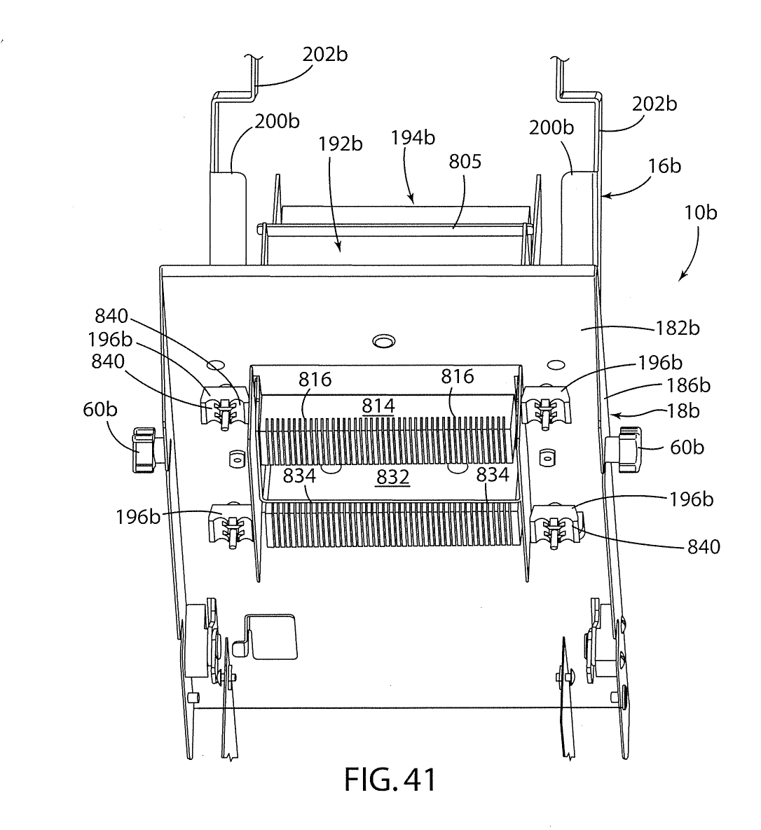

The illustrated slicer 10b can include any of the features of the previously described embodiments. For example, the cover 18b can be pivotally connected to the base 17b as described above or can be connected to the base 17b as described in association with FIGS. 1-23. The slicer 10b can also include any output assembly as described above. Moreover, the slicer 10b can include cams 420b identical to the cams 420 described above. The cover 18b can also include the slider block closure blocks 196 as described above or can include slider block closure blocks 196b as illustrated in FIGS. 35 and 41, with the slider block closure blocks 196b each having a pair of rod grooves 840 for engaging the sliding rods 108b of the first slider assembly 74b and the second slider assembly 76b. Alternatively, the slide block closure blocks 196b could be only connected to the housing 14b, with a fastener going through a top of the slide block closure blocks 196b (but not the cover 16b) and directly into corresponding lower slide block closure blocks and into the bottom plate 46 of the platform 28.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. For example, while a particular assembly is described for moving the first slider assembly 74 and the second slider assembly 76 of the cutting blade assembly 12, it is contemplated that any system used to move the first slider assembly 74 and the second slider assembly 76 linearly could be used (e.g., a pair of linear actuators). Moreover, it is contemplated that other manners of tensioning the cutting blades 78 within the cutting blade assembly 12 could be used. Additionally, it is contemplated that the cover 18 and pusher handle 16 could be connected in any manner (e.g., the pusher handle 16 could only be connected to the cover 18 and rotate with the cover) and that the cover 18 and pusher handle 16 could be connected to any portion of the base 17 in any manner or could be separate from the base 17. Furthermore, it is contemplated that the slicer 10 could include a counter for counting the number revolutions of the cutting blade assembly (e.g., by counting the number of revolutions of the output shaft 68 of the motor 64) or for counting a number of times the unit is energized. Additionally, it is contemplated that the cutting blade assembly could only include a few cutting blades (e.g., 3 or 4) for cutting a loaf of bread or a bun into a plurality of slices of bread or a multi-level bun (i.e., one having a top and bottom bun along with at least one middle bun portion). Moreover, it is contemplated that the slicer 10 or 10b could include a feature that allows the handle 16 or 16b to be held upright (e.g., a pin that fits through the rear guard 194b (e.g., at the rear guide plate 822 or one of the side guide plates 824) and into or below the pusher block 844). Therefore, it is to be understood that the embodiment shown in the drawings and described above is provided principally for illustrative purposes and should not be used to limit the scope of the invention. Moreover, it is to be understood that such concepts are intended to be covered by the following claims unless these claims by their language expressly state otherwise.

We claim:

1. A method of slicing a bagel comprising:
providing a housing having a plurality of cutting blades;
moving the bagel past the cutting blades to slice the bagel into a plurality of bagel chips; and
moving the cutting blades linearly and reciprocally to slice the bagel.

2. The method of slicing a bagel of claim 1, further including:
moving the bagel through a slot in the housing, with the cutting blades being located in the slot;
pushing the bagel through the slot with a pusher.

3. The method of slicing a bagel of claim 2, further including:
extending a portion of the pusher between the cutting blades during slicing of the bagel.

4. The method of slicing a bagel of claim 2, wherein:
the cutting blades do not start moving until a top opening of the slot is covered.

5. The method of slicing a bagel of claim 2, wherein:
the housing includes chute walls surrounding a top of the slot and the pusher extends between the chute walls.

6. The method of slicing a bagel of claim 5, wherein:
the chute walls contain the product during moving the bagel past the cutting blades.

7. The method of slicing a bagel of claim 1, wherein:
a cutting side of the blades are on a top of the blades.

8. The method of slicing a bagel of claim 1, wherein:
the cutting blades are located in a blade carriage and include a first set of cutting blades having a first side support member and a second side support member and a second set of cutting blades having a first side support member and a second side support member.

9. The method of slicing a bagel of claim 8, wherein:
the first set of cutting blades extend through the first side support member of the second set of cutting blades and the second set of cutting blades extend through the second side support member of the first set of cutting blades.

10. The method of slicing a bagel of claim 1, wherein:
the housing includes at least one comb guide for assisting in aligning the cutting blades during cutting of the bagel.

11. The method of slicing a bagel of claim 1, wherein:
the bagel is a toroid.

12. The method of slicing a bagel of claim 11, wherein:
the bagel is a ring toroid.

13. The method of slicing a bagel of claim 11, wherein:
the bagel is a horn toroid.

14. The method of slicing a bagel of claim 1, further including:
providing a first carriage having a first group of cutting blades therein, the first group of cutting blades having a first distance therebetween;
providing a second carriage having a second group of cutting blades therein, the second group of cutting blades having a second distance therebetween;
wherein the first distance is different than the second distance.

15. The method of slicing a bagel of claim 14, further including:
placing the first carriage into the housing to form bagel chips having a first thickness; and
placing the second carriage into the housing to form bagel chips having a second thickness;
wherein the first thickness is different than the second thickness; and
wherein placing the first carriage and the second carriage into the housing can be performed without any tools.

16. A method of slicing a bagel comprising:
providing a housing having a plurality of cutting blades;
moving the bagel past the cutting blades to slice the bagel into a plurality of bagel chips;
wherein a distance between adjacent cutting blades is equal to or less than 0.5 inches.

17. The method of slicing a bagel of claim 16, further including:
moving the bagel through a slot in the housing, with the cutting blades being located in the slot;
pushing the bagel through the slot with a pusher.

18. The method of slicing a bagel of claim 17, further including:
extending a portion of the pusher between the cutting blades during slicing of the bagel.

19. The method of slicing a bagel of claim 17, wherein:
the cutting blades do not start moving until a top opening of the slot is covered.

20. The method of slicing a bagel of claim 17, wherein:
the housing includes chute walls surrounding a top of the slot and the pusher extends between the chute walls.

21. The method of slicing a bagel of claim 20, wherein:
the chute walls contain the product during moving the bagel past the cutting blades.

22. The method of slicing a bagel of claim 16, wherein:
a cutting side of the blades are on a top of the blades.

23. The method of slicing a bagel of claim 16, wherein:
the cutting blades are located in a blade carriage and include a first set of cutting blades having a first side support member and a second side support member and a second set of cutting blades having a first side support member and a second side support member.

24. The method of slicing a bagel of claim 23, wherein:
the first set of cutting blades extend through the first side support member of the second set of cutting blades and the second set of cutting blades extend through the second side support member of the first set of cutting blades.

25. The method of slicing a bagel of claim 16, wherein:
the housing includes at least one comb guide for assisting in aligning the cutting blades during cutting of the bagel.

26. The method of slicing a bagel of claim 16, wherein:
the bagel is a toroid.

27. The method of slicing a bagel of claim 26, wherein:
the bagel is a ring toroid.

28. The method of slicing a bagel of claim 26, wherein:
the bagel is a horn toroid.

29. The method of slicing a bagel of claim 16, wherein:
the distance between adjacent cutting blades is equal to or less than 0.25 inches.

30. The method of slicing a bagel of claim 29, wherein:
the distance between adjacent cutting blades is equal to or less than 0.125 inches.

31. The method of slicing a bagel of claim 16, further including:
providing a first carriage having a first group of cutting blades therein, the first group of cutting blades having a first distance therebetween;
providing a second carriage having a second group of cutting blades therein, the second group of cutting blades having a second distance therebetween;
wherein the first distance is different than the second distance.

32. The method of slicing a bagel of claim 31, further including:
placing the first carriage into the housing to form bagel chips having a first thickness; and
placing the second carriage into the housing to form bagel chips having a second thickness;
wherein the first thickness is different than the second thickness; and
wherein placing the first carriage and the second carriage into the housing can be performed without any tools.

33. A method of slicing a bagel comprising:
providing a housing having a plurality of cutting blades;
moving the bagel past the cutting blades to slice the bagel into a plurality of bagel chips, with the bagel chips having a thickness equal to or less than 0.5 inches.

34. A method of slicing a whole bagel comprising:
providing a housing having a plurality of cutting blades;
moving the whole bagel past the cutting blades to slice the bagel into a plurality of bagel chips;
wherein only one whole bagel is sliced during moving; and
wherein multiple bagel chips are simultaneously formed during moving the whole bagel past the cutting blades.

35. The method of slicing a bagel of claim 34, further including:
moving the bagel through a slot in the housing, with the cutting blades being located in the slot;
pushing the bagel through the slot with a pusher.

36. The method of slicing a bagel of claim 35, further including:
extending a portion of the pusher between the cutting blades during slicing of the bagel.

37. The method of slicing a bagel of claim 35, wherein:
the cutting blades do not start moving until a top opening of the slot is covered.

38. The method of slicing a bagel of claim 35, wherein:
the housing includes chute walls surrounding a top of the slot and the pusher extends between the chute walls.

39. The method of slicing a bagel of claim 38, wherein:
the chute walls contain the product during moving the bagel past the cutting blades.

40. The method of slicing a bagel of claim 34, wherein:
a cutting side of the blades are on a top of the blades.

41. The method of slicing a bagel of claim 34, wherein:
the cutting blades are located in a blade carriage and include a first set of cutting blades having a first side support member and a second side support member and a second set of cutting blades having a first side support member and a second side support member.

42. The method of slicing a bagel of claim 41, wherein:
the first set of cutting blades extend through the first side support member of the second set of cutting blades and the second set of cutting blades extend through the second side support member of the first set of cutting blades.

43. The method of slicing a bagel of claim 34, wherein:
the housing includes at least one comb guide for assisting in aligning the cutting blades during cutting of the bagel.

44. The method of slicing a bagel of claim 34, wherein:
the bagel is a toroid.

45. The method of slicing a bagel of claim 44, wherein:
the bagel is a ring toroid.

46. The method of slicing a bagel of claim 44, wherein:
the bagel is a horn toroid.

47. The method of slicing a bagel of claim 34, further including:
providing a first carriage having a first group of cutting blades therein, the first group of cutting blades having a first distance therebetween;
providing a second carriage having a second group of cutting blades therein, the second group of cutting blades having a second distance therebetween;
wherein the first distance is different than the second distance.

48. The method of slicing a bagel of claim 47, further including:
placing the first carriage into the housing to form bagel chips having a first thickness; and
placing the second carriage into the housing to form bagel chips having a second thickness;
wherein the first thickness is different than the second thickness; and
wherein placing the first carriage and the second carriage into the housing can be performed without any tools.

49. A bagel slicing apparatus comprising:
a housing having a plurality of cutting blades comprising a first set of cutting blades and a second set of cutting blades;
the first set of cutting blades moving as a first unit; and
the second set of cutting blades moving as a second unit;
wherein the first set of cutting blades moves out of phase to the second set of cutting blades; and
wherein a distance between adjacent cutting blades is equal to or less than 0.5 inches.

50. A bagel slicing apparatus comprising:
a housing having a plurality of cutting blades comprising a first set of cutting blades and a second set of cutting blades;
the first set of cutting blades moving as a first unitary unit; and
the second set of cutting blades moving as a second unitary unit;
wherein the first set of cutting blades moves out of phase to the second set of cutting blades; and
wherein the cutting blades move linearly and reciprocally to slice the bagel.
